(19) United States
(12) Patent Application Publication
(10) Pub. No.: US 2025/0146891 A1
(43) Pub. Date: May 8, 2025

(54) LOAD SENSOR

(71) Applicant: Panasonic Intellectual Property Management Co., Ltd., Osaka (JP)

(72) Inventors: Susumu URAGAMI, Kumamoto (JP); Takafumi HAMANO, Fukuoka (JP); Yuta MORIURA, Osaka (JP); Takashi MATSUMOTO, Osaka (JP); Hironobu UKITSU, Osaka (JP); Yodai MATSUMURA, Osaka (JP)

(21) Appl. No.: 19/018,925

(22) Filed: Jan. 13, 2025

Related U.S. Application Data
(63) Continuation of application No. PCT/JP2023/021681, filed on Jun. 12, 2023.

(30) Foreign Application Priority Data
Jul. 25, 2022 (JP) 2022-118314

(51) Int. Cl. G01L 1/14

(52) U.S. Cl. CPC G01L 1/14

(57) ABSTRACT

A load sensor includes: a first base member; a second base member covering at least a first region of the first base member; a plurality of conductor wires disposed so as to extend across the first region and a second region of the first base member adjacent to the first region; a plurality of electrically-conductive elastic bodies each crossing the plurality of conductor wires; a dielectric body disposed between the conductor wire and the electrically-conductive elastic body; a substrate set on the first base member in the second region and having electrodes to which the plurality of conductor wires are fixed by solder; and a structure configured to dispose, at an approximately identical plane, a first portion included in the first region and a second portion extending from the first portion to the second region, of each of the plurality of conductor wires.

### CROSS REFERENCE TO RELATED APPLICATION

This application is a continuation of International Application No. PCT/JP2023/021681 filed on Jun. 12, 2023, entitled “LOAD SENSOR”, which claims priority under 35 U.S.C. Section 119 of Japanese Patent Application No. 2022-118314 filed on Jul. 25, 2022, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2020/153029 describes a pressure-sensitive element (load sensor) that includes: a sheet-shaped base member including an elastic electrically-conductive part; a plurality of conductor wires disposed so as to cross the elastic electrically-conductive part; a plurality of dielectric bodies respectively disposed between the plurality of conductor wires and the elastic electrically-conductive part; a thread-shaped member that sews the plurality of conductor wires to the base member; and a sheet-shaped member that opposes the elastic electrically-conductive part via the conductor wires and the dielectric bodies.

In the above load sensor, a substrate having a wiring pattern is set on the surface of the base member on which the elastic electrically-conductive part is formed, and an end portion of each conductor wire is soldered to an electrode disposed on the surface of this substrate. In this case, the conductor wire is raised from the surface of the base member onto the surface of the substrate, and thus, is bent by the thickness of the substrate. This bending causes a gap between: the base member; and the conductor wire and the sheet-shaped member, near the boundary of the substrate, and in the region where this gap has been generated, the load detection characteristic becomes unstable. On the other hand, if this region is excluded from the effective region of the load sensor, the effective region of the load sensor is narrowed, accordingly.

### SUMMARY OF THE INVENTION

A main aspect of the present invention relates to a load sensor. The load sensor according to the present aspect includes: a first base member; a second base member covering at least a first region of the first base member; a plurality of conductor wires disposed so as to extend across the first region and a second region of the first base member adjacent to the first region; a plurality of electrically-conductive elastic bodies disposed on at least one of opposing faces of the first base member and the second base member, the plurality of electrically-conductive elastic bodies each crossing the plurality of conductor wires; a dielectric body disposed between the conductor wire and the electrically-conductive elastic body; a substrate set on the first base member in the second region and having electrodes to which the plurality of conductor wires are fixed by solder; and a structure configured to dispose, at an approximately identical plane, a first portion included in the first region and a second portion extending from the first portion to the second region, of each of the plurality of conductor wires.

In the load sensor according to the present aspect, the first portion of each of the plurality of conductor wires included in the first region and the second portion of each of the plurality of conductor wires extending from the first portion to the second region are disposed at an approximately identical plane. Therefore, the plurality of conductor wires are inhibited from being bent in the up-down direction near the boundary between the first region and the second region, and generation of a gap between: the first base member; and each conductor wire and the second base member near this boundary is inhibited. Therefore, the load detection characteristic can be inhibited from becoming unstable near the boundary of the substrate.

The effects and the significance of the present invention will be further clarified by the description of the embodiments below. However, the embodiments below are merely some examples for implementing the present invention. The present invention is not limited to the description of the embodiments below in any way.

### BRIEF DESCRIPTION OF THE DRAWINGS

FIG. 1A is a plan view schematically showing a configuration of a structure in a manufacturing step according to Embodiment 1;

FIG. 1B is a plan view schematically showing a configuration of a structure in a manufacturing step according to Embodiment 1;

FIG. 2A is a plan view schematically showing a configuration of a structure in a manufacturing step according to Embodiment 1;

FIG. 2B is a cross-sectional view of the structure in FIG. 2A according to Embodiment 1;

FIG. 3A is a plan view schematically showing a configuration of a structure in a manufacturing step according to Embodiment 1;

FIG. 3B is a cross-sectional view of the structure in FIG. 3A according to Embodiment 1;

FIG. 4A is a plan view schematically showing a configuration of a load sensor according to Embodiment 1;

FIG. 4B is a cross-sectional view of the load sensor in FIG. 4A according to Embodiment 1;

FIG. 5 is a plan view schematically showing a configuration of the load sensor according to Embodiment 1;

FIG. 6A and FIG. 6B each schematically show a cross section of the vicinity of a crossing position between an electrically-conductive elastic body and a wire when the load sensor is cut at the crossing position according to Embodiment 1;

FIG. 7A is a cross-sectional view showing a configuration of the load sensor according to Embodiment 1;

FIG. 7B is a cross-sectional view showing a configuration of a load sensor according to Comparative Example;

FIG. 8A is a plan view schematically showing a configuration of a structure in a manufacturing step according to Embodiment 2;

FIG. 8B is a cross-sectional view of the structure in FIG. 8A according to Embodiment 2;

FIG. 9A is a plan view schematically showing a configuration of a structure in a manufacturing step according to Embodiment 2;

FIG. 9B is a cross-sectional view of the structure in FIG. 9A according to Embodiment 2;

FIG. 10A is a plan view schematically showing a configuration of a load sensor according to Embodiment 2;

FIG. 10B is a cross-sectional view of the load sensor in FIG. 10A according to Embodiment 2;

FIG. 11A is a plan view schematically showing a configuration of a substrate according to Embodiment 3;

FIG. 11B is a plan view schematically showing a configuration of a structure in a manufacturing step according to Embodiment 3;

FIG. 12A is a plan view schematically showing a configuration of a structure in a manufacturing step according to Embodiment 3;

FIG. 12B is a cross-sectional view of the structure in FIG. 12A according to Embodiment 3;

FIG. 13A is a plan view schematically showing a configuration of a structure in a manufacturing step according to Embodiment 3;

FIG. 13B is a cross-sectional view of the structure in FIG. 13A according to Embodiment 3;

FIG. 14A is a plan view schematically showing a configuration of a load sensor according to Embodiment 3;

FIG. 14B is a cross-sectional view of the load sensor in FIG. 14A according to Embodiment 3;

FIG. 15A is a plan view schematically showing a configuration of a load sensor according to Modification 1 of Embodiment 3;

FIG. 15B is a cross-sectional view of the load sensor in FIG. 15A according to Modification 1 of Embodiment 3;

FIG. 16A is a plan view schematically showing a configuration of a load sensor according to Modification 2 of Embodiment 3;

FIG. 16B is a cross-sectional view of the load sensor in FIG. 16A according to Modification 2 of Embodiment 3;

FIG. 17A is a plan view schematically showing a configuration of a load sensor according to Modification 3 of Embodiment 3;

FIG. 17B is a cross-sectional view of the load sensor in FIG. 17A according to Modification 3 of Embodiment 3;

FIG. 18 is a plan view schematically showing a configuration of a structure in a manufacturing step according to Embodiment 4;

FIG. 19A is a plan view schematically showing a configuration of a structure in a manufacturing step according to Embodiment 4;

FIG. 19B is a cross-sectional view of the structure in FIG. 19A according to Embodiment 4;

FIG. 20A is a plan view schematically showing a configuration of a structure in a manufacturing step according to Embodiment 4;

FIG. 20B is a cross-sectional view of the structure in FIG. 20A according to Embodiment 4;

FIG. 21A is a plan view schematically showing a configuration of a load sensor according to Embodiment 4;

FIG. 21B is a cross-sectional view of the load sensor in FIG. 21A according to Embodiment 4;

FIG. 22A is a plan view schematically showing a configuration of a structure in a manufacturing step according to a modification of Embodiment 4;

FIG. 22B is a cross-sectional view of the structure in FIG. 22A according to the modification of Embodiment 4;

FIG. 23A is a plan view schematically showing a configuration of a structure in a manufacturing step according to the modification of Embodiment 4;

FIG. 23B is a cross-sectional view of the structure in FIG. 23A according to the modification of Embodiment 4;

FIG. 24A is a plan view schematically showing a configuration of a load sensor according to the modification of Embodiment 4;

FIG. 24B is a cross-sectional view of the load sensor in FIG. 24A according to the modification of Embodiment 4;

FIG. 25A and FIG. 25B each schematically show a cross section of the vicinity of a crossing position between an electrically-conductive elastic body and a wire when the load sensor is cut at the crossing position according to another modification;

FIG. 26A is a cross-sectional view schematically showing a configuration of a load sensor according to still another modification; and

FIG. 26B schematically shows a cross section of the vicinity of a crossing position between an electrically-conductive elastic body and a wire when the load sensor is cut at the crossing position according to still another modification.

It is noted that the drawings are solely for description and do not limit the scope of the present invention in any way.

### DETAILED DESCRIPTION

A load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiments below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiments below is connected to a detection circuit, and the load sensor and the detection circuit form a load detection device. The embodiments below are examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

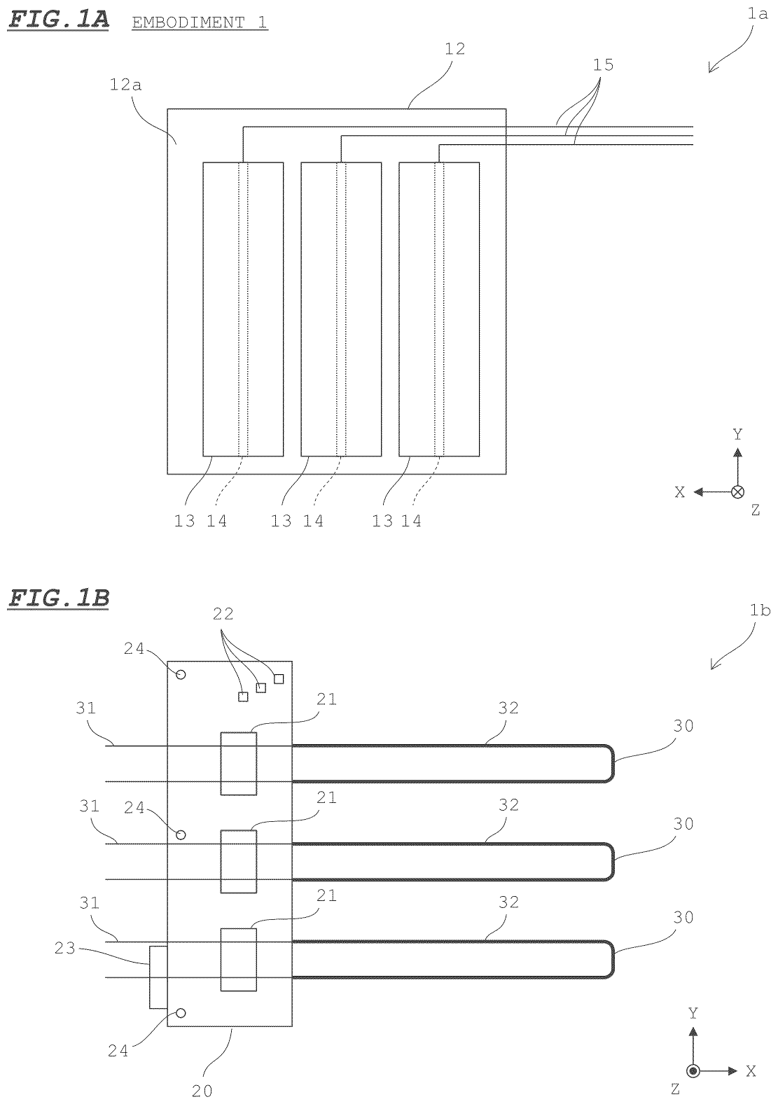

FIG. 1A is a plan view schematically showing a configuration of a structure 1a in a manufacturing step.

The structure 1a includes a second base member 12, a plurality of electrically-conductive elastic bodies 13, a plurality of electric conductors 14, and a plurality of wiring cables 15.

The second base member 12 is a flat-plate-shaped member having elasticity. The second base member 12 has a rectangular shape in a plan view. The thickness of the second base member 12 is constant. When the thickness of the second base member 12 is small, the second base member 12 may be referred to as a sheet member or a film member. The second base member 12 is disposed so as to overlap a first base member 11 described later.

The second base member 12 has an insulation property, and is formed from a non-electrically-conductive resin material or a non-electrically-conductive rubber material, for example. The resin material used in the second base member 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the second base member 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 13 each have a band-like shape that is rectangular and long in the Y-axis direction and are arranged in the X-axis direction with a predetermined gap therebetween. That is, the long side of the electrically-conductive elastic body 13 is parallel to the Y-axis, and the arrangement direction of the electrically-conductive elastic bodies 13 is parallel to the X-axis. Each electrically-conductive elastic body 13 is an electrically-conductive member having elasticity.

The electric conductors 14 are formed on an opposing face 12a (the face on the Z-axis negative side) of the second base member 12. Here, three electric conductors 14 are disposed on the opposing face 12a of the second base member 12 so as to extend in the Y-axis direction. Each electric conductor 14 is formed from a material having a resistance lower than that of each electrically-conductive elastic body 13. Here, the electric conductor 14 is an electrically-conductive member having elasticity. A wiring cable 15 is drawn from an end portion on the Y-axis positive side of each electric conductor 14.

Each electrically-conductive elastic body 13 is formed on the opposing face 12a of the second base member 12 so as to cover a corresponding electric conductor 14. Each electric conductor 14 and a corresponding electrically-conductive elastic body 13 formed so as to cover the electric conductor 14 are in a state of being electrically connected to each other. The electric conductor 14 is positioned at an approximately middle position of the electrically-conductive elastic body 13 in the X-axis direction. Here, three electrically-conductive elastic bodies 13 are disposed on the opposing face 12a of the second base member 12. The width, the length, and the thickness of the three electrically-conductive elastic bodies 13 are the same with each other.

Each electric conductor 14 and each electrically-conductive elastic body 13 are formed on the opposing face 12a of the second base member 12 by a printing method such as screen printing, gravure printing, flexographic printing, offset printing, or gravure offset printing. After the electric conductor 14 has been formed on the opposing face 12a, the electrically-conductive elastic body 13 is formed on the opposing face 12a so as to overlap the electric conductor 14. With these printing methods, the electric conductor 14 and the electrically-conductive elastic body 13 can be formed so as to have a thickness of about 0.001 mm to 0.5 mm on the opposing face 12a. However, the forming method of the electric conductor 14 and the electrically-conductive elastic body 13 is not limited to the printing method.

Each electrically-conductive elastic body 13 and each electric conductor 14 are formed from a resin material and an electrically-conductive filler dispersed therein, or from a rubber material and an electrically-conductive filler dispersed therein.

Similar to the resin material used in the second base member 12 described above, the resin material used in the electrically-conductive elastic body 13 and the electric conductor 14 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the second base member 12 described above, the rubber material used in the electric conductor 14 and the electrically-conductive elastic body 13 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The material of the electrically-conductive filler used in the electrically-conductive elastic body 13 and the electric conductor 14 is a material of at least one type selected from the group consisting of: metal materials such as Au (gold), Ag (silver), Cu (copper), C (carbon), Zno (zinc oxide), In₂O₃ (indium oxide (III)), and SnO₂ (tin oxide (IV)); electrically-conductive macromolecule materials such as PEDOT: PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

For example, the electrically-conductive filler used in the electric conductor 14 is Ag (silver), and the electrically-conductive filler forming the electrically-conductive elastic body 13 is C (carbon).

FIG. 1B is a plan view schematically showing a configuration of a structure 1b in a manufacturing step.

The structure 1b includes a substrate 20 and a plurality of wires 30.

The substrate 20 is a printed board for connecting the wiring cables 15 and the wires 30 to an external detection circuit. The substrate 20 has a rectangular shape that is long in the Y-axis direction. On the face on the Z-axis positive side of the substrate 20, three electrodes 21 and three electrodes 22 are formed. At an end portion on the X-axis negative side of the substrate 20, three holes 24 arranged in the Y-axis direction are formed, and further, a connector 23 is set.

The three electrodes 21 and the three electrodes 22 are connected to six terminals of the connector 23, respectively. As described later, conductor wires 31 of three wires 30 are respectively connected to the three electrodes 21, and three wiring cables 15 are respectively connected to the three electrodes 22. The connector 23 is used in order to connect the conductor wires 31 of the wires 30 and the wiring cables 15 to the external detection circuit via the electrodes 21, 22.

The plurality of wires 30 are disposed so as to extend in the X-axis direction. Here, three wires 30 are disposed. In a state of being bent, each wire 30 is disposed on a jig. Each wire 30 is composed of a conductor wire 31 and a dielectric body 32 covering the surface of the conductor wire 31. At two end portions on the X-axis negative side of each wire 30, the dielectric body 32 is omitted, and the conductor wire 31 is exposed. As described later, the portion of the exposed conductor wire 31 of each wire 30 is superposed on a corresponding electrode 21, and is joined to the electrode 21 by solder.

Each conductor wire 31 is a member having electrical conductivity and having a linear shape. The conductor wire 31 is formed from an electrically-conductive metal material, for example. Other than this, the conductor wire 31 may be composed of a core wire made of glass and an electrically-conductive layer formed on the surface of the core wire. Alternatively, the conductor wire 31 may be composed of a core wire made of resin, and an electrically-conductive layer formed on the surface of the core wire, for example. For example, as the conductor wire 31, a valve action metal such as aluminum (Al), titanium (Ti), tantalum (Ta), niobium (Nb), zirconium (Zr), or hafnium (Hf); tungsten (W); molybdenum (Mo); copper (Cu); nickel (Ni); silver (Ag); gold (Au); or the like is used. In Embodiment 1, the conductor wire 31 is formed from copper. The conductor wire 31 may be a twisted wire obtained by twisting wire members made of an electrically-conductive metal material.

The dielectric body 32 has an electric insulation property, and is formed from a resin material, a ceramic material, a metal oxide material, or the like, for example. The dielectric body 32 may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 32 may be a metal oxide material of at least one type selected from the group consisting of Al₂O₃, Ta₂O₅, and the like.

The diameter of the conductor wire 31 is 0.01 mm or more and 1.5 mm or less, for example, or may be 0.05 mm or more and 0.8 mm or less. Such a configuration of the conductor wire 31 is preferable from the viewpoint of the resistance and the strength of the conductor wire 31. The thickness of the dielectric body 32 is preferably 5 nm or more and 100 μm or less, and can be selected as appropriate according to the design of the sensitivity of the sensor and the like.

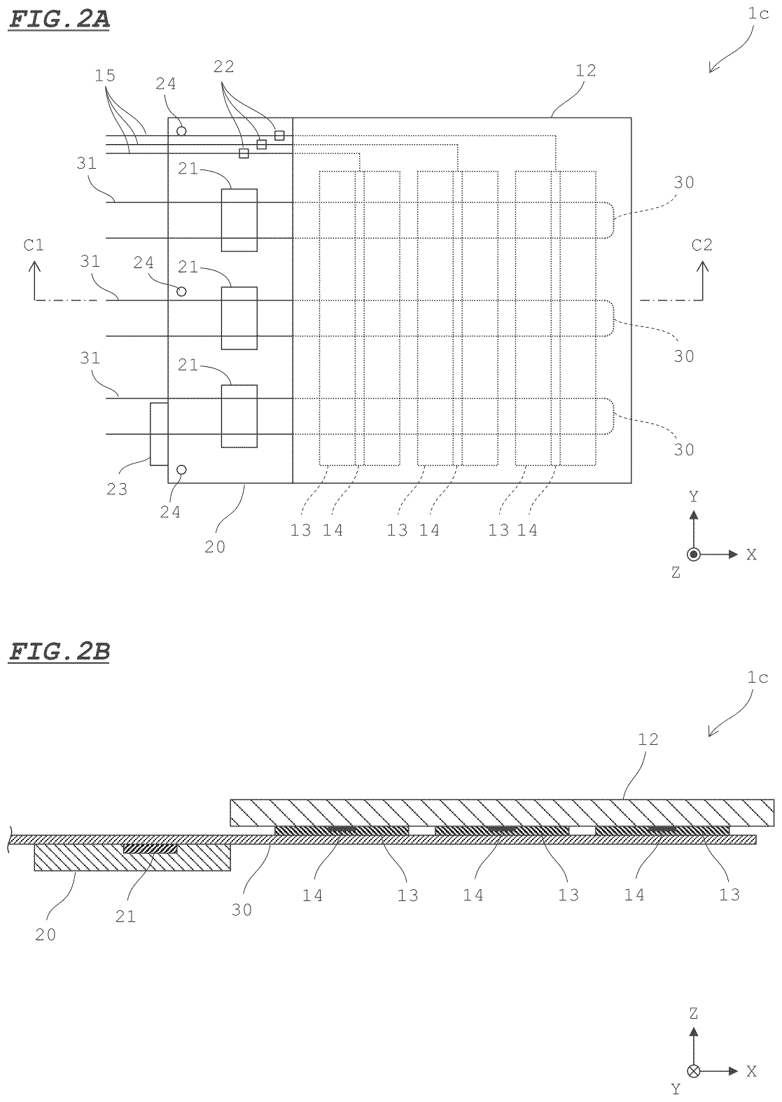

FIG. 2A is a plan view schematically showing a configuration of a structure 1c in a manufacturing step. FIG. 2B is a C1-C2 cross-sectional view of the structure 1c in FIG. 2A. In FIG. 2A, the configurations on the far side with respect to the second base member 12 are indicated by broken lines.

The structure 1a in FIG. 1A is flipped upside down and superposed on the structure 1b in FIG. 1B. Accordingly, the surfaces of the three electrically-conductive elastic bodies 13 overlap the wires 30. In a state of traversing the three electrically-conductive elastic bodies 13 in the X-axis direction, each wire 30 crosses these electrically-conductive elastic bodies 13.

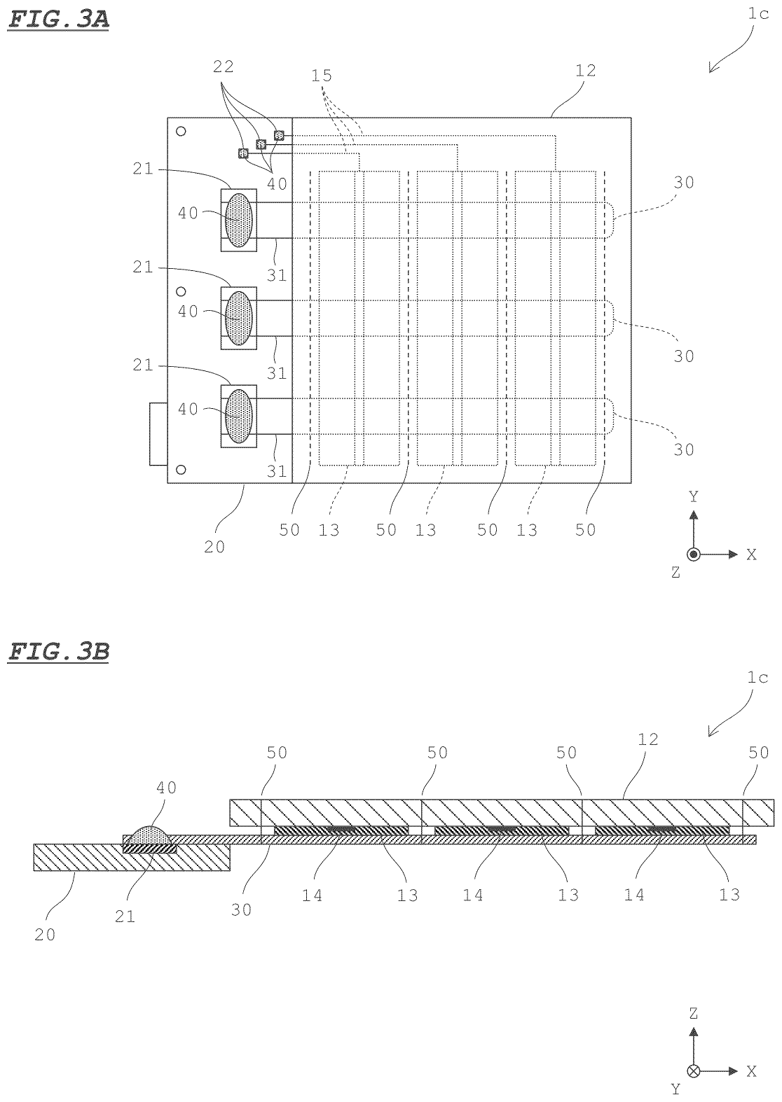

FIG. 3A is a plan view showing a state where the wires 30 are fixed by solder 40 and threads 50 in the structure 1c in FIG. 2A. FIG. 3B is a cross-sectional view obtained by cutting the structure 1c in FIG. 3A at the position of C1-C2 in FIG. 2A.

In the state shown in FIGS. 2A, 2B, the solder 40 is applied to an end portion of the wire 30 overlapping the electrode 21, whereby the conductor wire 31 exposed in the end portion of the wire 30 is joined to the electrode 21. In addition, the solder 40 is applied to the wiring cable 15 overlapping the electrode 22, whereby the wiring cable 15 is joined to the electrode 22. Further, in a plan view, in the gap between adjacent electrically-conductive elastic bodies 13 and in regions on the outer side of the electrically-conductive elastic bodies 13 at both ends, the three wires 30 are sewn and fastened to the second base member 12 by the threads 50. In a state of being sewn and fastened by the threads 50, the three wires 30 are movable in the X-axis direction, and is restricted in movement in the Y-axis direction by the threads 50. The thread 50 is implemented by a chemical fiber, a natural fiber, a mixed fiber of the chemical fiber and the natural fiber, or the like.

Then, in a state where the three wires 30 are joined by the solder 40 to the electrodes 21 on the substrate 20, portions, of the wires 30, on the X-axis negative side with respect to the electrodes 21 are cut off. In addition, in a state where the three wiring cables 15 are joined by the solder 40 to the electrodes 22 on the substrate 20, portions, of the wiring cables 15, on the X-axis negative side with respect to the electrodes 22 are cut off.

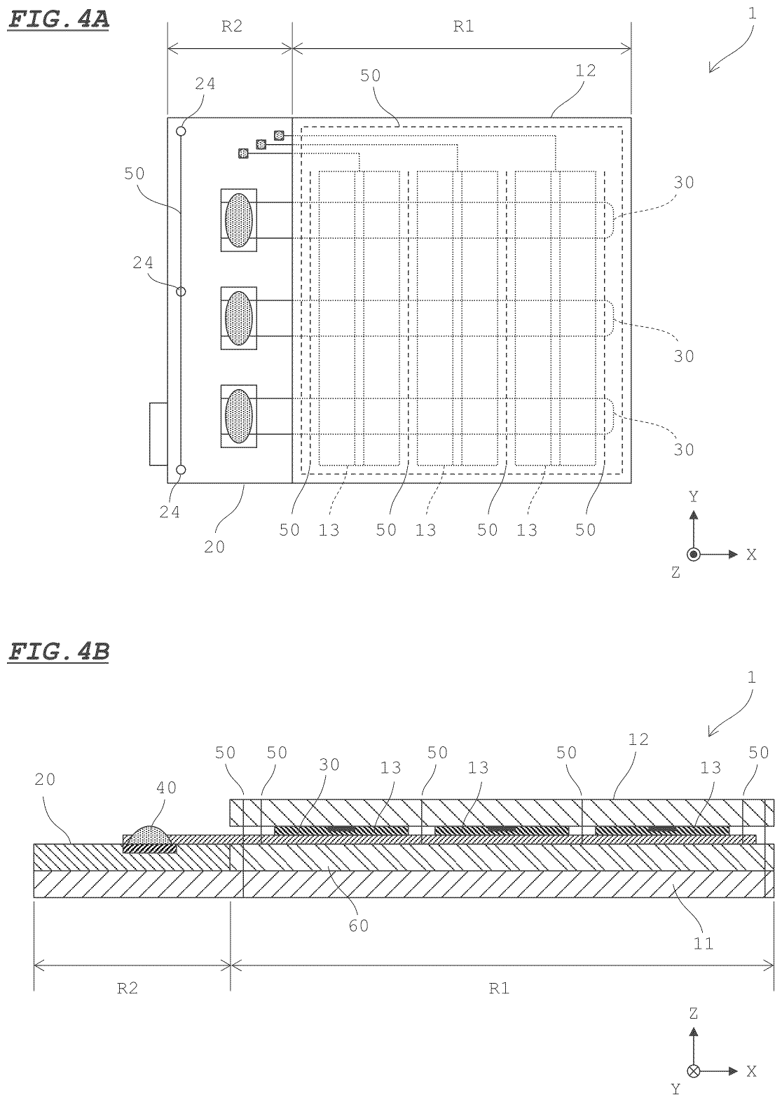

FIG. 4A is a plan view schematically showing a configuration of the load sensor 1. FIG. 4B is a cross-sectional view obtained by cutting the load sensor 1 in FIG. 4A at the position of C1-C2 in FIG. 2A.

The load sensor 1 includes the structure 1c in FIGS. 3A, 3B, the first base member 11, and a spacer 60.

The first base member 11 is a flat-plate-shaped member. In a plan view, the first base member 11 has a rectangular shape. In a plan view, the width in the Y-axis direction of the first base member 11 is the same as that of the second base member 12, and the width in the X-axis direction of the first base member 11 is larger than that of the second base member 12. The thickness of the first base member 11 is constant. When the thickness of the first base member 11 is small, the first base member 11 may be referred to as a sheet member or a film member.

The first base member 11 has an insulation property, and is formed from a non-electrically-conductive resin material or a non-electrically-conductive rubber material, for example. The first base member 11 can be formed from a material that can be used in the second base member 12 described above, for example. The first base member 11 may be formed from a hard material that is less likely to be elastically deformed.

The first base member 11 is sectioned into a first region R1 and a second region R2 in the X-axis direction. That is, the first region R1 and the second region R2 are adjacent to each other in the X-axis direction. The second base member 12 is superposed on the first region R1, and the substrate 20 is set on the second region R2. In a plan view, the first region R1 has approximately the same shape and size as the second base member 12, and the second region R2 has approximately the same shape and size as the substrate 20.

The spacer 60 is a flat-plate-shaped member. In a plan view, the spacer 60 has a rectangular shape. The spacer 60 is set on the first region R1 of the first base member 11. The shape and size of the spacer 60 in a plan view are approximately the same those of the first region R1. The thickness of the spacer 60 is substantially the same as the thickness of the substrate 20 and is constant in the entire range.

The spacer 60 has an insulation property, and is formed from a non-electrically-conductive resin material or a non-electrically-conductive rubber material, for example. The spacer 60 can be formed from a material similar to that of the first base member 11, for example. The spacer 60 may be formed from a hard material that is less likely to be elastically deformed.

In a state where the spacer 60 is disposed on the first region R1, the first base member 11 is superposed on the structure 1c in FIGS. 3A, 3B from below (the Z-axis negative side). Accordingly, the wires 30 come into contact with the upper face (the face on the Z-axis positive side) of the spacer 60. Then, the outer periphery of the second base member 12 is connected to the first base member 11 by a thread 50. As a result, the second base member 12 is fixed to the first base member 11. Further, via the three holes 24 provided in the substrate 20, the substrate 20 is connected to the first base member 11 by a thread 50. As a result, the substrate 20 is fixed to the first base member 11. Then, the load sensor 1 is completed as shown in FIGS. 4A, 4B.

The load sensor 1 is used in a state where the second base member 12 is oriented upward (the Z-axis positive side) and the first base member 11 is oriented downward (the Z-axis negative side). In this case, an upper face 12b of the second base member 12 serves as the face to which a load is applied, and a lower face 11b of the first base member 11 is set on an installation surface.

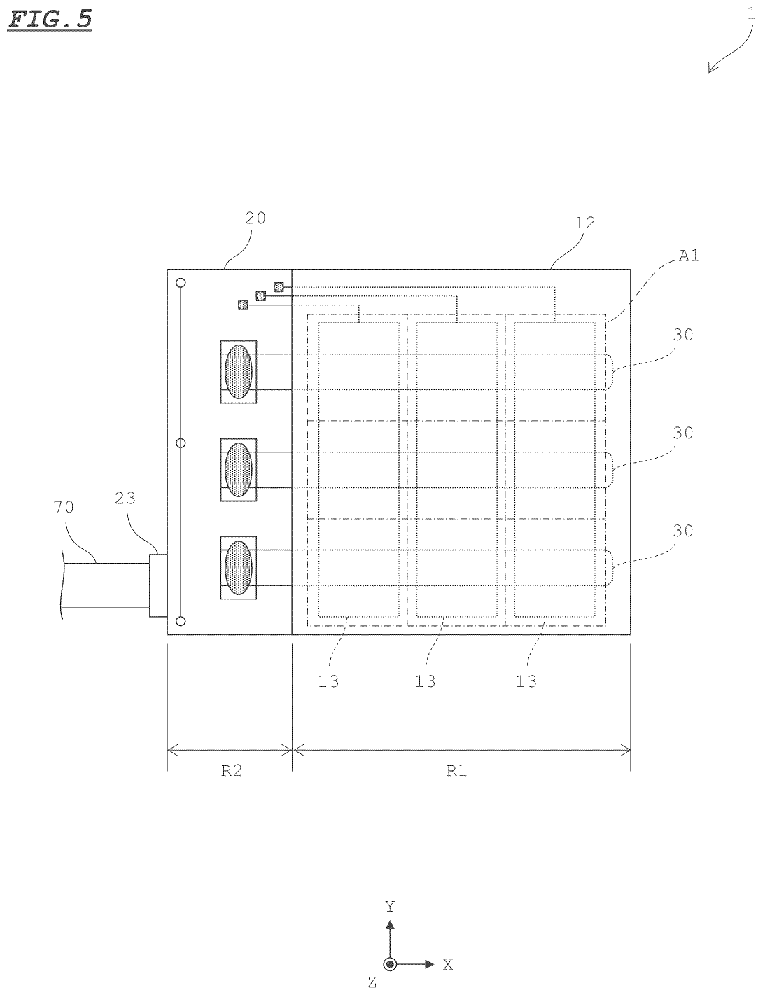

Here, in the load sensor 1, in a plan view, a plurality of element parts A1 arranged in a matrix shape are formed as shown in FIG. 5. In the load sensor 1 in FIG. 5, a total of nine element parts A1 arranged in the X-axis direction and the Y-axis direction are formed. One element part A1 corresponds to a region including the crossing position between one electrically-conductive elastic body 13 and a wire 30 disposed below the electrically-conductive elastic body 13. The region composed of these nine element parts A1 is the effective region of load detection in the load sensor 1.

The load sensor 1 is connected to a detection circuit via a cable 70 connected to the connector 23. When the lower face (the lower face of the first base member 11) of the load sensor 1 is set on a predetermined installation surface, and a load is applied to the upper face (the upper face of the second base member 12) of the load sensor 1 forming the element part A1, the capacitance between the electrically-conductive elastic body 13 and the conductor wire 31 changes and the load is detected based on the capacitance.

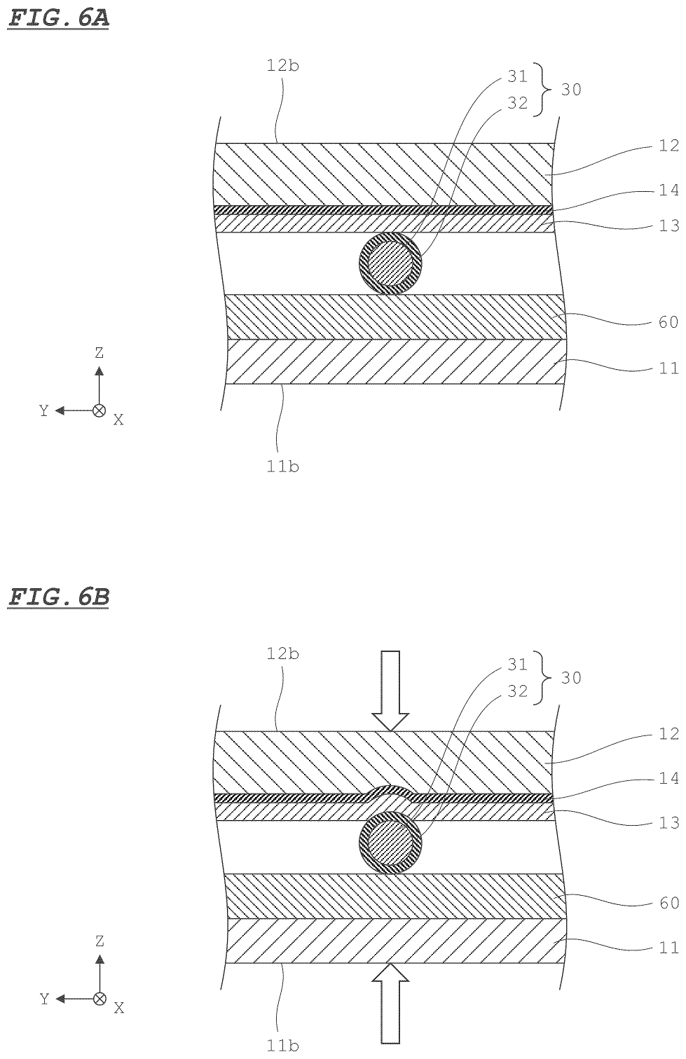

FIGS. 6A, 6B each schematically show a cross section of the vicinity of the crossing position between the electrically-conductive elastic body 13 and the wire 30 when the load sensor 1 is cut at the crossing position by a plane parallel to a Y-Z plane.

FIG. 6A shows a state where no load is applied, and

FIG. 6B shows a state where loads are applied. In FIGS. 6A, 6B, the lower face 11b on the Z-axis negative side of the first base member 11 is set on the installation surface.

As shown in FIG. 6A, when no load is applied to the upper face 12b of the second base member 12, the force applied between the electrically-conductive elastic body 13 and the wire 30 is substantially zero. From this state, when a load is applied to the upper face 12b of the second base member 12, the electrically-conductive elastic body 13 is deformed by the wire 30, as shown in FIG. 6B. At this time, while being deformed so as to wrap the wire 30, the electrically-conductive elastic body 13 is brought close to the spacer 60, and the contact area between the wire 30 and the electrically-conductive elastic body 13 increases. Accordingly, the capacitance between the conductor wire 31 and the electrically-conductive elastic body 13 changes. Then, the voltage reflecting this change in capacitance is measured by the detection circuit, whereby the load is calculated.

As shown in FIG. 6B, when a load is applied to the upper face 12b of the second base member 12, the second base member 12 is elastically deformed together with electrically-conductive elastic body 13. Therefore, in order to smoothly increase the contact area by the electrically-conductive elastic body 13 being smoothly elastically deformed due to a load, it is preferable that the second base member 12 is formed from a soft material. For example, the second base member 12 can be formed from a rubber-based material having an A hardness of about 30 to 90 degrees, such as silicone rubber, fluorine-based rubber or EPDM rubber, or an elastomer-based material having physical properties close to those of these materials.

On the other hand, when the hardness of the first base member 11 and the spacer 60 is low, the first base member 11 and the spacer 60 are elastically deformed during load application, and elastic deformation of the electrically-conductive elastic body 13 and the maximum value of the contact area are suppressed. Accordingly, the maximum value of the load detection decreases. Therefore, it is preferable that the first base member 11 and the spacer 60 are formed from a material having a higher hardness than the second base member 12. In addition, since the spacer 60 comes into direct contact with the dielectric body 32 of the wire 30, it is preferable that the spacer 60 is formed from a material that is soft to some extent, so as not to damage the dielectric body 32 due to load application. For example, the spacer 60 can be implemented by an elastomer or polyurethane. The first base member 11 can also be formed from a material similar to this.

### Effects of Embodiment 1

According to Embodiment 1, the following effects are exhibited.

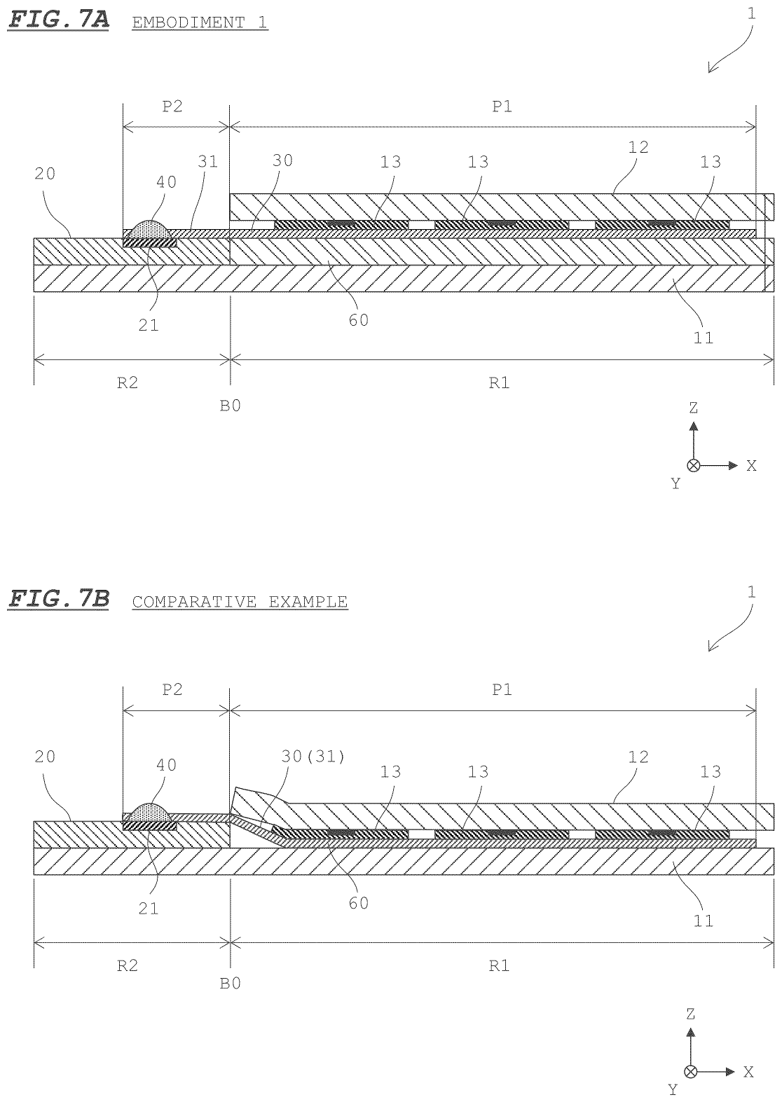

As shown in FIG. 7A, as a structure for disposing, at an approximately identical plane, a first portion P1 included in the first region R1 and a second portion P2 extending from the first portion P1 to the second region R2, of each of the plurality of conductor wires 31, the load sensor 1 includes the spacer 60 for aligning the height of the first portion P1 in the first region R1 with the height of the upper face of the substrate 20. Therefore, the first portions P1 and the second portions P2 of the plurality of conductor wires 31 are disposed at an approximately identical plane. Therefore, unlike Comparative Example in FIG. 7B, the plurality of conductor wires 31 are inhibited from being bent in the up-down direction near a boundary B0 between the first region R1 and the second region R2, and generation of a gap between: the first base member 11; and each conductor wire 31 and the second base member 12 near this boundary B0 is inhibited. Thus, the load detection characteristic can be inhibited from becoming unstable near the boundary B0 of the substrate 20.

### Embodiment 2

In Embodiment 1, the plurality of conductor wires 31 and the plurality of wiring cables 15 are joined by the solder 40 to the electrodes 21, 22 on the upper face of the substrate 20. In contrast, in Embodiment 2, the plurality of conductor wires 31 and the plurality of wiring cables 15 are joined by the solder 40 to the electrodes 21, 22 disposed on the lower face of the substrate 20.

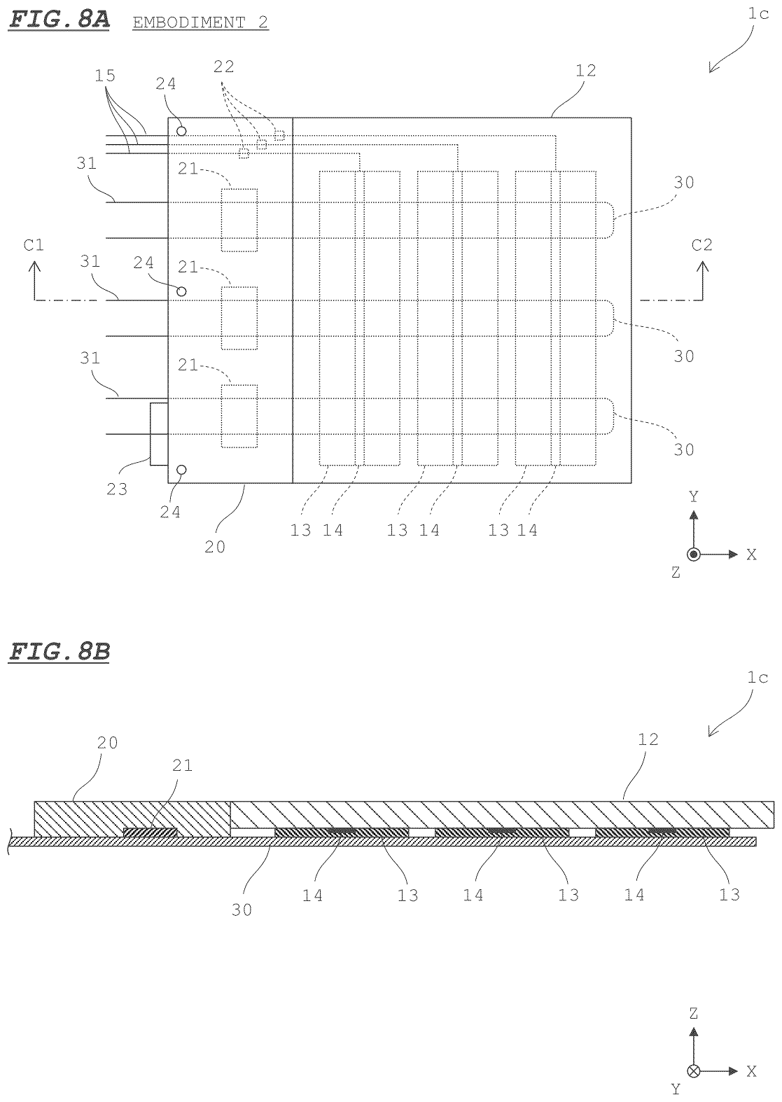

FIG. 8A is a plan view schematically showing a configuration of the structure 1c in a manufacturing step. FIG. 8B is a C1-C2 cross-sectional view of the structure 1c in FIG. 8A.

As shown in FIGS. 8A, 8B, in the structure 1c in Embodiment 2, the electrodes 21, 22 on the substrate 20 are disposed on the lower face of (the face on the Z-axis negative side) of the substrate 20. The position of the lower face of the substrate 20 in the Z-axis direction is approximately the same as the position of the lower face of each electrically-conductive elastic body 13 in the Z-axis direction. The configurations of the second base member 12, the electrically-conductive elastic bodies 13, and the electric conductors 14 are the same as those in Embodiment 1 above.

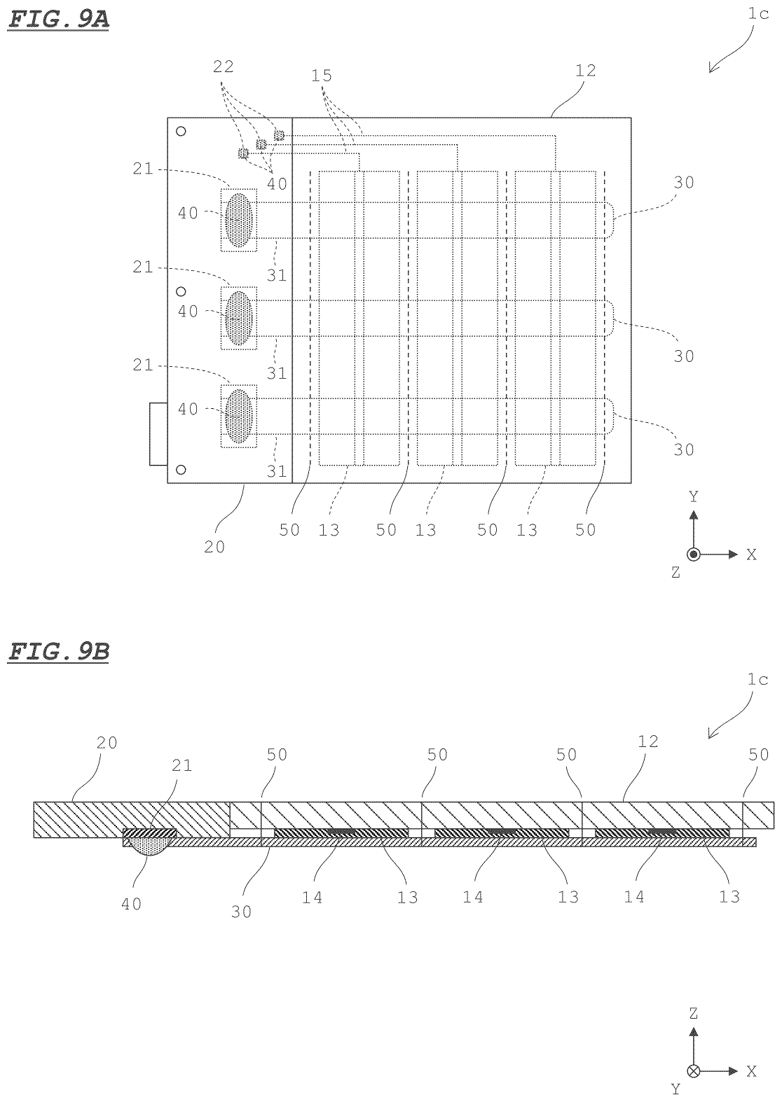

FIG. 9A is a plan view showing a state where the wires 30 are fixed by the solder 40 and the threads 50 in the structure 1c in FIG. 8A. FIG. 9B is a cross-sectional view obtained by cutting the structure 1c in FIG. 9A at the position of C1-C2 in FIG. 8A.

As shown in FIGS. 9A, 9B, in the structure 1c in Embodiment 2, since the electrodes 21, 22 are disposed on the lower face of the substrate 20, the plurality of conductor wires 31 and the plurality of wiring cables 15 are joined by the solder 40 to the electrodes 21, 22 on the lower face side of the substrate 20. The configuration for connecting the plurality of wires 30 to the second base member 12 is the same as that in Embodiment 1 above. Portions, of the wires 3, on the X-axis negative side with respect to the electrodes 21 and portions, of the wiring cables 15, on the X-axis negative side with respect to the electrodes 22 are cut off as in Embodiment 1 above.

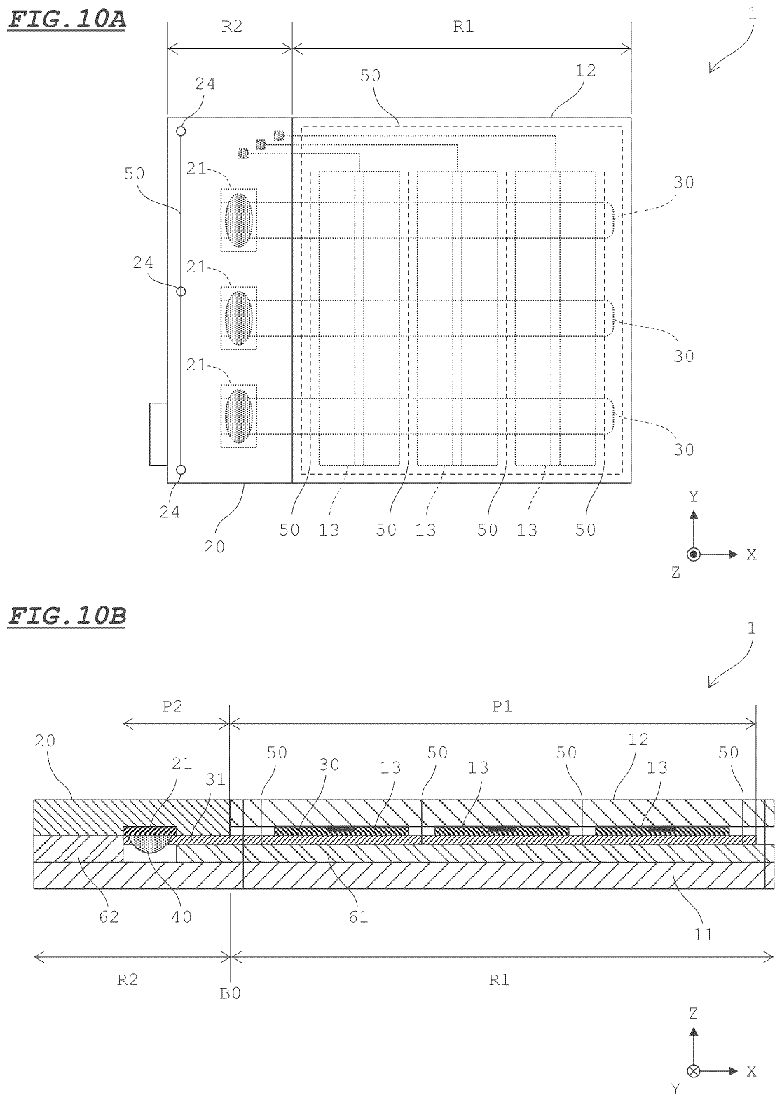

FIG. 10A is a plan view schematically showing a configuration of the load sensor 1 according to Embodiment 2. FIG. 10B is a cross-sectional view obtained by cutting the load sensor 1 in FIG. 10A at the position of C1-C2 in FIG. 8A.

The load sensor 1 includes the structure 1c in FIGS. 9A, 9B, the first base member 11, and spacers 61, 62.

The first base member 11 has the same configuration as that in Embodiment 1 above. The spacers 61, 62 are spacers for: filling the gap generated between the lower face of the substrate 20 and the upper face of the first base member 11, with the solder 40 that joins the second portion P2 of the wire 30 to the electrode 21; and disposing the first portion P1 and the second portion P2 at an approximately identical plane. The thickness of the spacer 62 is the same as the maximum thickness of the solder 40 or larger than this maximum thickness. The thickness of the spacer 61 is smaller than the thickness of the spacer 62 by about the diameter of the wire 30.

The shape of the spacer 61, 62 in a plan view is rectangular. The width in the Y-axis direction of the spacer 61, 62 is approximately the same as the width in the Y-axis direction of the first base member 11. The width in the X-axis direction of the spacer 61 is the same as the width from the edge on the X-axis positive side of the first base member 11 to the edge on the X-axis positive side of the electrode 21, or is slightly smaller than this width. The width in the X-axis direction of the spacer 62 is the same as the width from the edge on the X-axis negative side of the first base member 11 to the edge on the X-axis negative side of the electrode 21, or slightly smaller than this width. The spacers 61, 62 can be formed from a material similar to that of the spacer 60 in Embodiment 1 above.

The structure 1c in FIGS. 9A, 9B and the first base member 11 are joined to each other by the threads 50 as in Embodiment 1 above. Then, the load sensor 1 is completed.

### Effects of Embodiment 2

According to Embodiment 2, the following effects are exhibited.

As shown in FIGS. 10A, 10B, as a structure for disposing, at an approximately identical plane, the first portion P1 included in the first region R1 and the second portion P2 extending from the first portion P1 to the second region R2, of each of the plurality of conductor wires 31, the load sensor 1 includes the spacers 61, 62 that: fill the gap generated between the lower face of the substrate 20 and the upper face of the first base member 11, with the solder 40 that joins the second portion P2 to the electrode 21; and dispose the first portion P1 and the second portion P2 at an approximately identical plane. Therefore, the first portions P1 and the second portions P2 of the plurality of conductor wires 31 are disposed at an approximately identical plane. Therefore, unlike Comparative Example in FIG. 7B, the plurality of conductor wires 31 are inhibited from being bent in the up-down direction near the boundary B0 between the first region R1 and the second region R2, and generation of a gap between: the first base member 11; and each conductor wire 31 and the second base member 12 near this boundary B0 is inhibited. Thus, the load detection characteristic can be inhibited from becoming unstable near the boundary B0 of the substrate 20.

In Embodiments 1, 2 above, the spacers 60, 61, 62 are set to the first base member 11 by the threads 50. However, when the first base member 11 is formed from a hard material that is difficult to be penetrated by a sewing needle, holes for allowing the sewing needle to pass therethrough are formed in the first base member 11 in advance. The method of setting the spacers 60, 61, 62 to the first base member 11 is not limited to the method of sewing and fastening by the threads 50, and the spacers 60, 61, 62 may be set to the upper face the first base member 11 with an adhesive, for example.

In Embodiments 1, 2 above, the spacers 60, 61, 62 are prepared separately from the first base member 11. However, the spacer 60 or the spacers 61, 62 may be formed integrally with the first base member 11.

### Embodiment 3

In Embodiments 1, 2 above, the structure for disposing, at an approximately identical plane, the first portion P1 and the second portion P2 of each of the plurality of conductor wires 31 is the spacers 60, 61, 62. In Embodiment 3, this structure is a groove formed in the substrate 20.

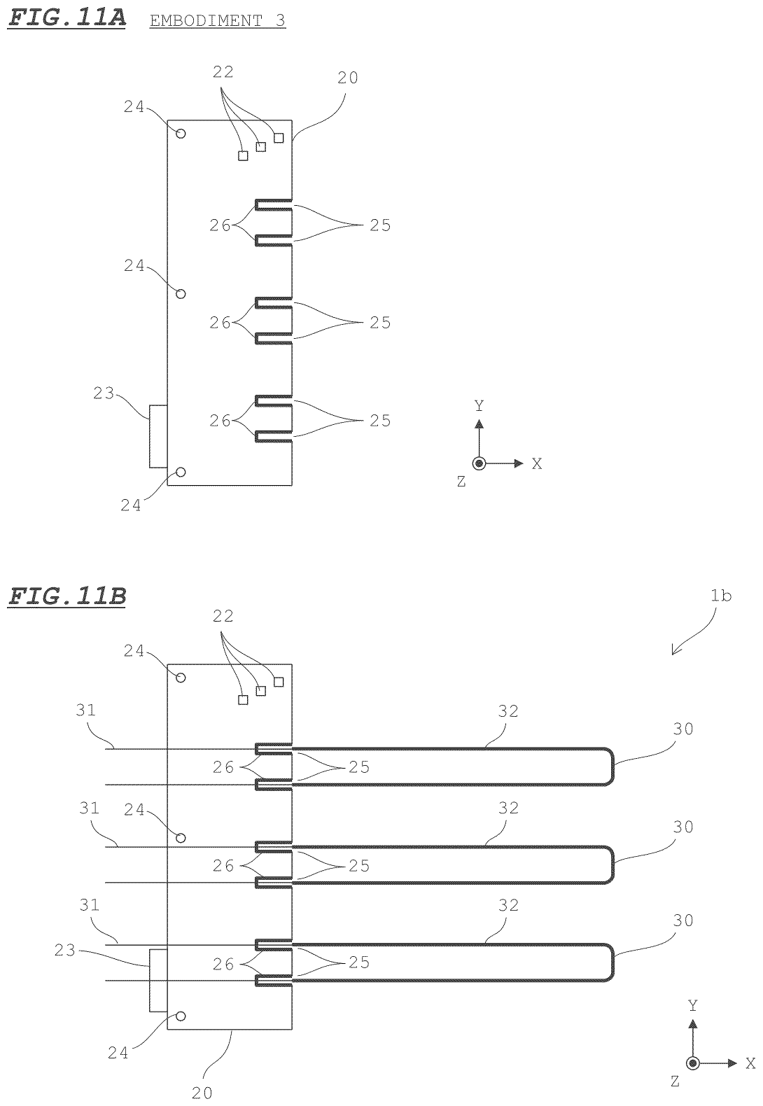

FIG. 11A is a plan view showing a configuration of the substrate 20 according to Embodiment 3.

The substrate 20 has formed therein a plurality of grooves 25 extending inwardly (the X-axis negative direction) from the boundary on the X-axis positive side. The plurality of grooves 25 each have a rectangular shape and penetrate the substrate 20 in the Z-axis direction. An electrode 26 is disposed at the inner side face of each groove 25. Two grooves 25 on the Y-axis positive side are electrically connected in the substrate 20 and are connected to a corresponding terminal of the connector 23. Two grooves 25 at the center are electrically connected in the substrate 20 and are connected to a corresponding terminal of the connector 23. Two grooves 25 on the Y-axis negative side are electrically connected in the substrate 20 and are connected to a corresponding terminal of the connector 23. The other configurations of the substrate 20 are the same as those in Embodiment 1 above.

FIG. 11B is a plan view schematically showing a configuration of the structure 1b in a manufacturing step.

The three wires 30 are disposed, in a state of being bent by a jig, on the upper face of the substrate 20. The conductor wires 31 of the three wires 30 are respectively disposed in the grooves 25.

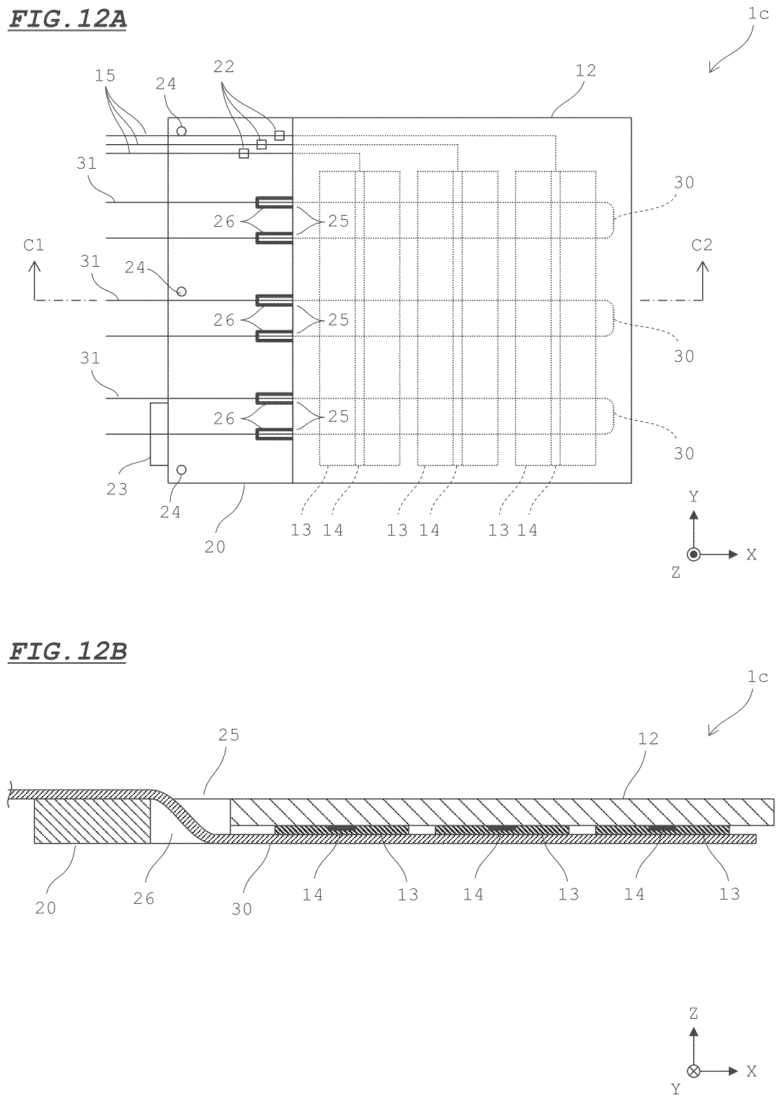

FIG. 12A is a plan view schematically showing a configuration of the structure 1c in a manufacturing step. FIG. 12B is a C1-C2 cross-sectional view of the structure 1c in FIG. 12A.

The structure 1a in FIG. 1A shown in Embodiment 1 is flipped upside down and superposed on the structure 1b in FIG. 11B. Accordingly, the surfaces of the three electrically-conductive elastic bodies 13 overlap the wires 30. In a state of traversing the three electrically-conductive elastic bodies 13 in the X-axis direction, each wire 30 crosses these electrically-conductive elastic bodies 13.

As shown in FIG. 12B, each of the plurality of wires 30 is bent upwardly inside the groove 25, to be raised onto the upper face of the substrate 20. This state has already been realized by routing the plurality of wires 30 on the upper face of the substrate 20 by a jig, in the structure 1b in FIG. 11B. Then, the structure 1a in FIG. 1A is flipped upside down and superposed on this structure 1b, whereby the structure 1c in FIG. 12B is formed.

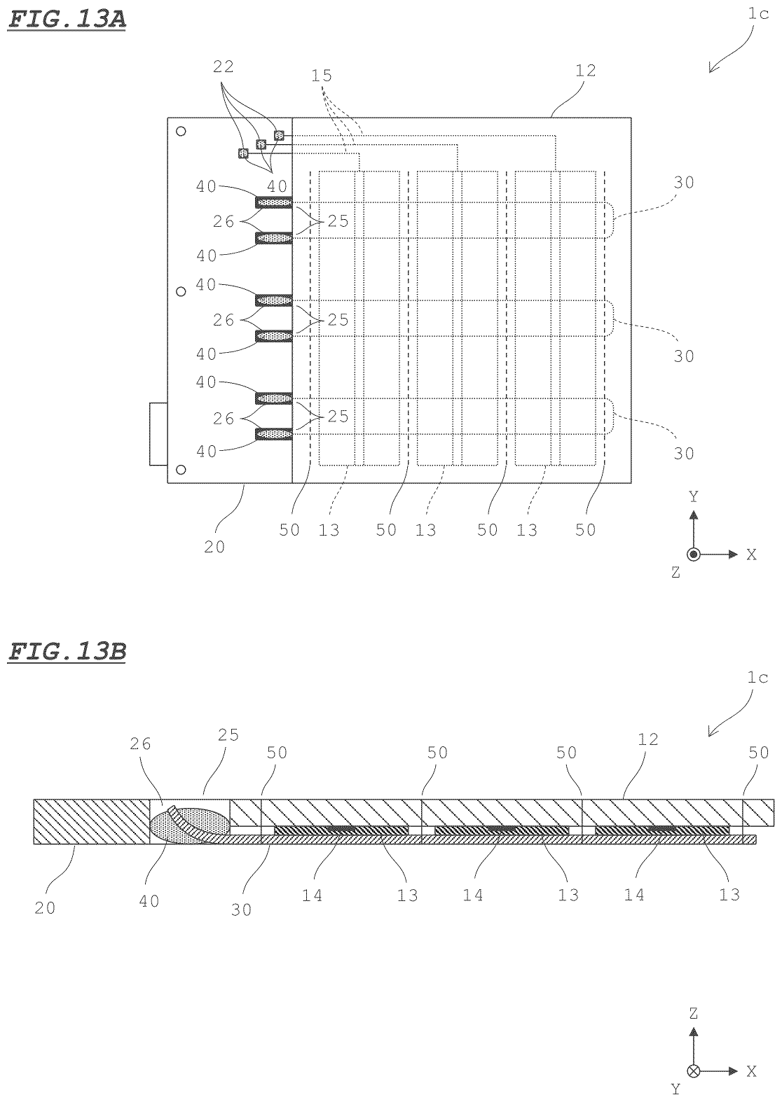

FIG. 13A is a plan view showing a state where the wires 30 are fixed by the solder 40 and the threads 50 in the structure 1c in FIG. 12A. FIG. 13B is a cross-sectional view obtained by cutting the structure 1c in FIG. 13A at the position of C1-C2 in FIG. 12A.

In the state shown in FIGS. 12A, 12B, the solder 40 is applied to each of the plurality of grooves 25. Accordingly, the conductor wire 31 of the wire 30 included in each groove 25 is joined by the solder 40 to the electrode 26 disposed at the inner side face of the groove 25. In addition, as in Embodiment 1 above, the wiring cables 15 are joined by the solder 40 to the electrodes 22. Further, as in Embodiment 1 above, the three wires 30 are sewn and fastened to the second base member 12 by the threads 50.

Then, in a state where the three wires 30 are joined by the solder 40 to the electrodes 26 at the substrate 20, portions, of the wires 30, on the X-axis negative side with respect to the electrodes 26 are cut off. In addition, portions, of the three wiring cable 15, on the X-axis negative side with respect to the electrodes 22 are cut off.

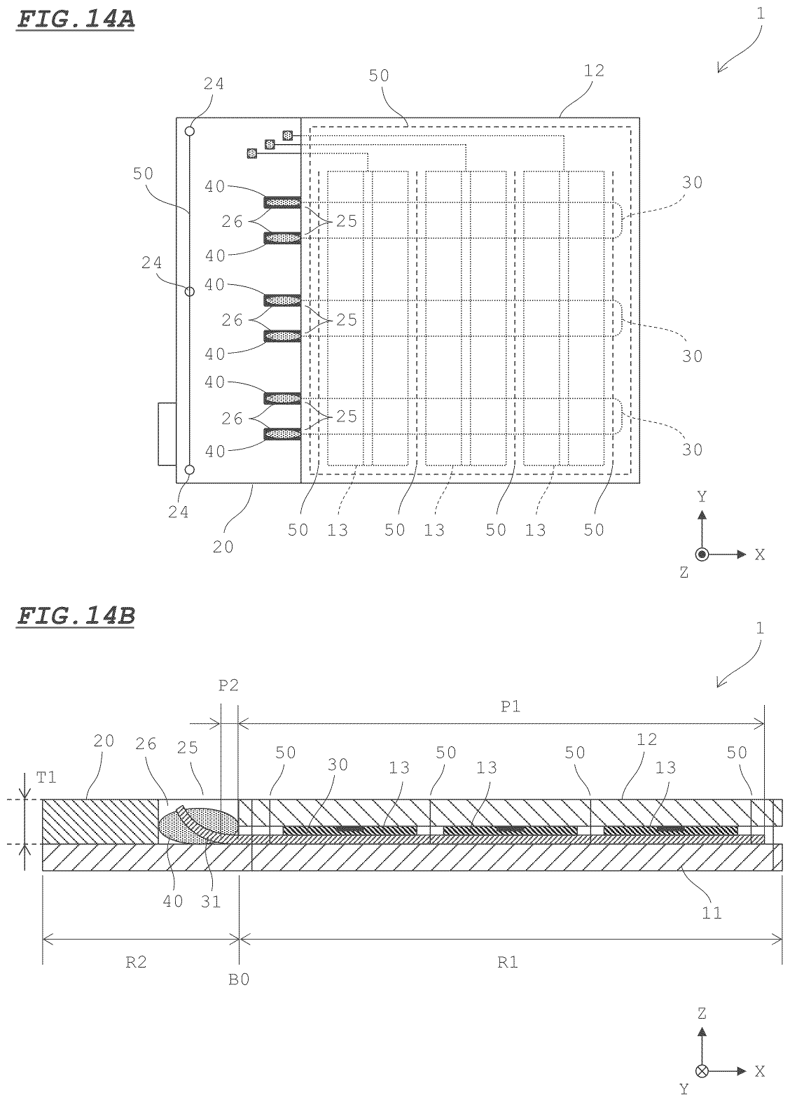

FIG. 14A is a plan view schematically showing a configuration of the load sensor 1. FIG. 14B is a cross-sectional view obtained by cutting the load sensor 1 in FIG. 14A at the position of C1-C2 in FIG. 12A.

The load sensor 1 includes the structure 1c in FIGS. 13A, 13B and the first base member 11. The first base member 11 has the same configuration as that in Embodiment 1 above. The first base member 11 is superposed on the structure 1c in FIGS. 13A, 13B from below (the Z-axis negative side). Then, the outer periphery of the second base member 12 is connected to the first base member 11 by a thread 50. As a result, the second base member 12 is fixed to the first base member 11. Further, via the three holes 24 provided in the substrate 20, the substrate 20 is connected to the first base member 11 by a thread 50. As a result, the substrate 20 is fixed to the first base member 11. Then, the load sensor 1 is completed as shown in FIGS. 14A, 14B.

As shown in FIG. 14B, in a state where the load sensor 1 is completed, the electrode 26, the solder 40, and the conductor wire 31 joined to the electrode 26 in the groove 25 are disposed in the range of a thickness T1 of the substrate 20. The height of the upper face of the substrate 20 and the height of the upper face of the second base member 12 are approximately the same. With this configuration, the load sensor 1 having a compact shape can be realized.

### Effects of Embodiment 3

As shown in FIGS. 14A, 14B, as a structure for disposing, at an approximately identical plane, the first portion P1 included in the first region R1 and the second portion P2 extending from the first portion P1 to the second region R2, of each of the plurality of conductor wires 31, the load sensor 1 includes the plurality of grooves 25 that are formed in the substrate 20 so as to extend inwardly (the X-axis negative direction) from the boundary of the substrate 20 on the first region R1 side, and in which the second portions P2 of the plurality of conductor wires 31 are respectively disposed. Accordingly, the first portions P1 and the second portions P2 near the boundary B0 are disposed at an approximately identical plane. Therefore, unlike Comparative Example in FIG. 7B, the plurality of conductor wires 31 are inhibited from being bent in the up-down direction near the boundary B0 between the first region R1 and the second region R2, and generation of a gap between: the first base member 11; and each conductor wire 31 and the second base member 12 near this boundary B0 is inhibited. Thus, the load detection characteristic can be inhibited from becoming unstable near the boundary B0 of the substrate 20.

According to the configuration of Embodiment 3, without use of the spacers unlike Embodiments 1, 2 above, and with a simple configuration in which the grooves 25 are formed in the substrate 20, the first portions P1 and the second portions P2 of the plurality of conductor wires 31 can be disposed at an approximately identical plane. Therefore, the configuration of the load sensor 1 can be simplified.

As shown in FIGS. 14A, 14B, the electrode 26 is disposed at the periphery of each groove 25, and in a state of being accommodated in the groove 25, the conductor wire 31 is joined by the solder 40 to the electrode 26. More specifically, in a state where the electrode 26 is disposed at the inner side face of each groove 25 and the conductor wire 31 is accommodated in the groove 25, the solder 40 is applied to the groove 25, whereby the conductor wire 31 is joined by the solder to the electrode 26. With this configuration, since the conductor wire 31 is accommodated in the groove 25, the load sensor 1 can be made thinner as compared with a case where the conductor wire 31 is routed and fixed by the solder onto the upper face of the substrate 20. In addition, through a simple step of applying the solder 40 to the groove 25 in a state where the conductor wire 31 is accommodated in the groove 25, the conductor wire 31 and the electrode 26 can be electrically joined to each other.

In the above configuration, the electrode 26 is disposed at the inner side face of the groove 25. However, not limited thereto, as long as the conductor wire 31 can be joined to the electrode 26 by solder in a state where the conductor wire 31 is accommodated in the groove 25, the electrode 26 may be disposed at the periphery of the groove 25 in another form. For example, the electrode 26 may be disposed from the inner side face of the groove 25 to the upper face of the substrate 20, or the electrode 26 may be disposed only on the upper face of the substrate 20 along the groove 25.

As shown in FIG. 14B, the electrode 26, the solder 40, and the conductor wire 31 joined to the electrode 26 in the groove 25 are disposed in the range of the thickness T1 of the substrate 20. Therefore, the solder 40 and the conductor wire 31 in the groove 25 do not protrude beyond the range of the thickness of the substrate 20, and the load sensor 1 can be made further thinner.

### Modification 1 of Embodiment 3

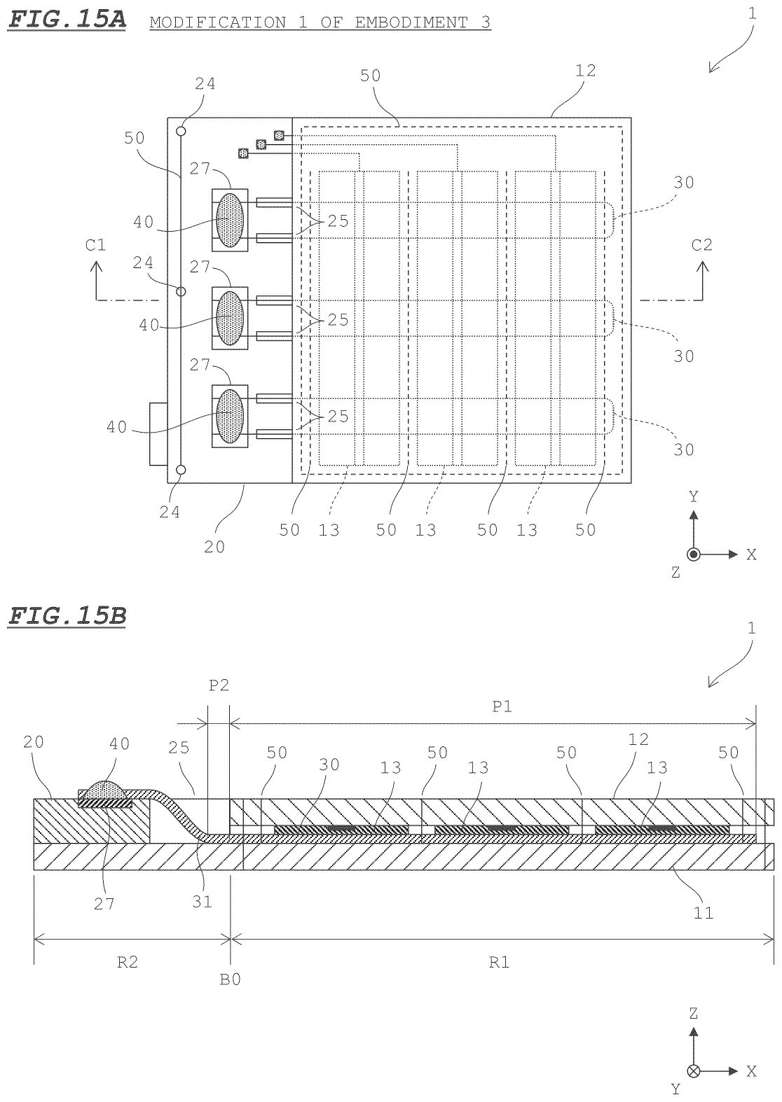

FIG. 15A is a plan view schematically showing a configuration of the load sensor 1 according to Modification 1 of Embodiment 3. FIG. 15B is a C1-C2 cross-sectional view of the load sensor 1 in FIG. 15A.

As shown in FIGS. 15A, 15B, in this Modification 1, a plurality of electrodes 27 are disposed on the upper face of the substrate 20 on the far side with respect to the plurality of grooves 25, and each conductor wire 31 is bent so as to be raised from the state of being accommodated in the groove 25 onto the upper face of the substrate 20, to be joined to the electrode 27 by the solder 40. At this time, each conductor wire 31 is adjusted by a jig such that the second portion P2 is at an approximately identical plane with respect to the first portion P1. The plurality of electrodes 27 are each connected to a corresponding terminal of the connector 23, similar to the electrodes 21 in Embodiment 1 above. The other configurations of the load sensor 1 according to Modification 1 are the same as those in Embodiment 3 above.

According to the configuration of Modification 1 as well, the first portions P1 and the second portions P2 near the boundary B0 are disposed at an approximately identical plane. Therefore, unlike Comparative Example in FIG. 7B, the plurality of conductor wires 31 are inhibited from being bent in the up-down direction near the boundary B0 between the first region R1 and the second region R2, and generation of a gap between: the first base member 11; and each conductor wire 31 and the second base member 12 near this boundary B0 is inhibited. Thus, in Modification 1 as well, the load detection characteristic can be inhibited from becoming unstable near the boundary B0 of the substrate 20.

In the configuration of Modification 1, since the conductor wire 31 is joined to the electrode 27 by the solder 40 on the upper face of the substrate 20, the thickness of the load sensor 1 is increased by the height of the solder 40. Therefore, in order to make the load sensor 1 thin, it can be said that the configuration of Embodiment 3 above is preferable.

### Modification 2 of Embodiment 3

In the configuration of Embodiment 3 above, the solder 40 is present up to the vicinity of the boundary on the X-axis positive side of the groove 25, as shown in FIG. 14B. Therefore, if the load sensor 1 is bent at the boundary in the up-down direction, the conductor wire 31 near this boundary fixed by the solder 40 may be broken at the solder 40 end, and disconnection may be caused in the conductor wire 31. In order to eliminate such a problem, in Modification 2, a bending inhibition member that inhibits the load sensor 1 from being bent in the up-down direction at the boundary B0 between the first region R1 and the second region R2 is disposed in the load sensor 1.

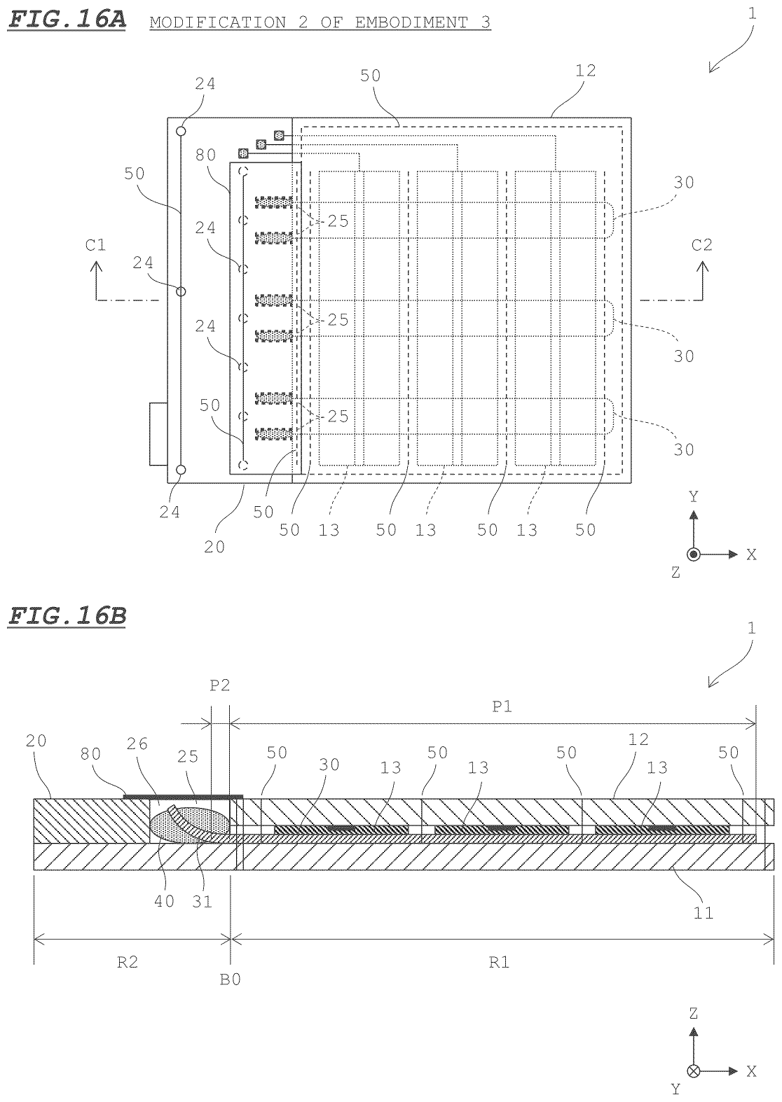

FIG. 16A is a plan view schematically showing a configuration of the load sensor 1 according to Modification 2 of Embodiment 3. FIG. 16B is a C1-C2 cross-sectional view of the load sensor 1 in FIG. 16A.

As shown in FIGS. 16A, 16B, in this Modification 2, a reinforcement film 80 is disposed as the bending inhibition member that inhibits the load sensor 1 from bending in the up-down direction at the boundary B0 between the first region R1 and the second region R2.

In a plan view, the reinforcement film 80 has a rectangular shape that is long in the Y-axis direction. The reinforcement film 80 is formed from a material that has a high tensile strength and that has a certain level of flexibility. That is, the reinforcement film 80 is required to have a tensile strength that can inhibit the upper end of the substrate 20 and the upper end of the second base member 12 from being separated from each other. Since the reinforcement film 80 is fixed to the second base member 12, the reinforcement film 80 is required to have a certain level of flexibility that does not cause undesired influence on deformation of the second base member 12 due to the load. The reinforcement film 80 is formed from polyimide or PET, for example.

The reinforcement film 80 may be an adhesive tape formed from such a material. In this case, the reinforcement film 80 can be easily attached to the vicinity of the boundary B0.

The reinforcement film 80 is disposed on the upper face of the second base member 12 and the upper face of the substrate 20 so as to extend across the boundary B0 between the first region R1 and the second region R2. In this state, in the reinforcement film 80, an end portion on the X-axis positive side is sewn to the second base member 12 and the first base member 11 by a thread 50, and further, an end portion on the X-axis negative side is sewn to the substrate 20 and the first base member 11 by a thread 50. In the substrate 20, a plurality of holes 24 for allowing a sewing needle to pass therethrough are formed at positions where the reinforcement film 80 is sewn.

Then, the reinforcement film 80 is fixed to the load sensor 1. The configurations of the load sensor 1 other than the reinforcement film 80 and the configuration for fixing the reinforcement film 80 are the same as those in Embodiment 3 above. The fixation of the end portion on the X-axis positive side of the reinforcement film 80 may be performed by a thread 50 for fixing the second base member 12 and the first base member 11 together, i.e., a thread 50 that is sewn along the periphery of the first region R1.

In the configuration in FIGS. 16A, 16B, not only the reinforcement film 80 but also the first base member 11 forms the bending inhibition member. That is, the first base member 11 is disposed on the lower face of the second base member 12 and the lower face of the substrate 20 so as to extend across the boundary B0 between the first region R1 and the second region R2. Therefore, when the second base member 12 and the substrate 20 are fixed to the first base member 11 by the threads 50 as described above, the lower end of the second base member 12 and the lower end of the substrate 20 are inhibited by the first base member 11 from being separated from each other.

Thus, according to the configuration of Modification 2, even if a force that may cause the load sensor 1 to be bent at the boundary B0 between the first region R1 and the second region R2 is applied to the load sensor 1, this bending is inhibited by the reinforcement film 80 and the first base member 11. Therefore, the conductor wire 31 near the boundary B0 fixed by the solder 40 can be inhibited from being broken at the solder 40 end due to this bending.

### Modification 3 of Embodiment 3

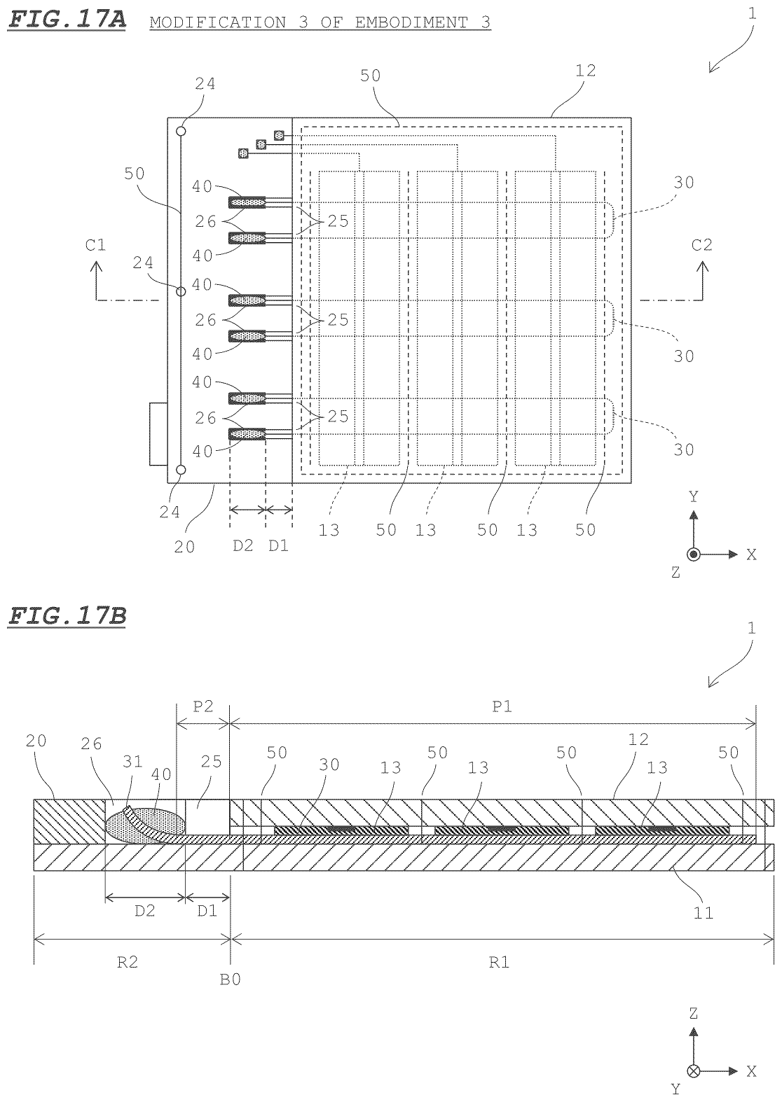

FIG. 17A is a plan view schematically showing a configuration of the load sensor 1 according to Modification 3 of Embodiment 3. FIG. 17B is a C1-C2 cross-sectional view of the load sensor 1 in FIG. 17A.

As shown in FIGS. 17A, 17B, in this Modification 3, the depth (the width in the X-axis direction) of each groove 25 is larger as compared with the configuration in FIGS. 14A, 14B. Then, in each groove 25, the electrode 26 is not disposed in a predetermined range D1 inward (the depth direction of the groove) of the boundary B0 between the first region R1 and the second region R2, and the electrode 26 is disposed in a range D2 on the far side with respect to the range D1. The other configurations of the load sensor 1 according to Modification 3 are the same as those in Embodiment 3 above.

According to the configuration of Modification 3, the position of the solder 40 is separated from the boundary B0 between the first region R1 and the second region R2. Therefore, even if the load sensor 1 is bent in the up-down direction at this boundary B0, the conductor wire 31 fixed by the solder 40 is not bent at the solder 40 end, and thus, the conductor wire 31 is not broken at the solder 40 end. Therefore, unlike Modification 2 above, even when the bending inhibition member is not separately provided, breakage of the conductor wire 31 can be inhibited.

However, in this Modification 3 as well, the bending inhibition member may be disposed as in Modification 2 above. Then, should the solder 40 reach the vicinity of the boundary B0, breakage of the conductor wire 31 can be inhibited.

In the configuration of Modification 3 as well, it is preferable that the electrode 26, the solder 40, and the conductor wire 31 joined to the electrode 26 in the groove 25 are disposed in the range of the thickness T1 of the substrate 20, as in Embodiment 3 above. Accordingly, the load sensor 1 can be made thin.

### Embodiment 4

In Embodiment 4, as compared with Embodiment 3, the formation positions of the grooves 25 and the electrodes 26 in the substrate 20 are different.

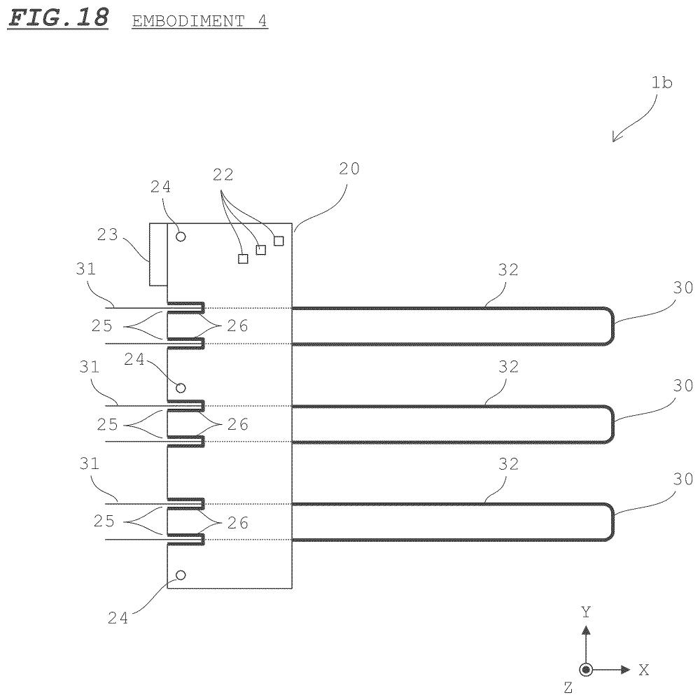

FIG. 18 is a plan view schematically showing a configuration of the structure 1b in a manufacturing step.

As shown in FIG. 18, in Embodiment 4, the plurality of grooves 25 are formed on the X-axis negative side of the substrate 20, and the electrodes 26 are respectively disposed at the inner side faces of these groove 25. As in Embodiment 3 above, each electrode 26 is connected to a corresponding terminal of the connector 23. The position where the connector 23 is disposed has been changed from Embodiment 3 above. The other configurations of the structure 1b are the same as those in Embodiment 3 above.

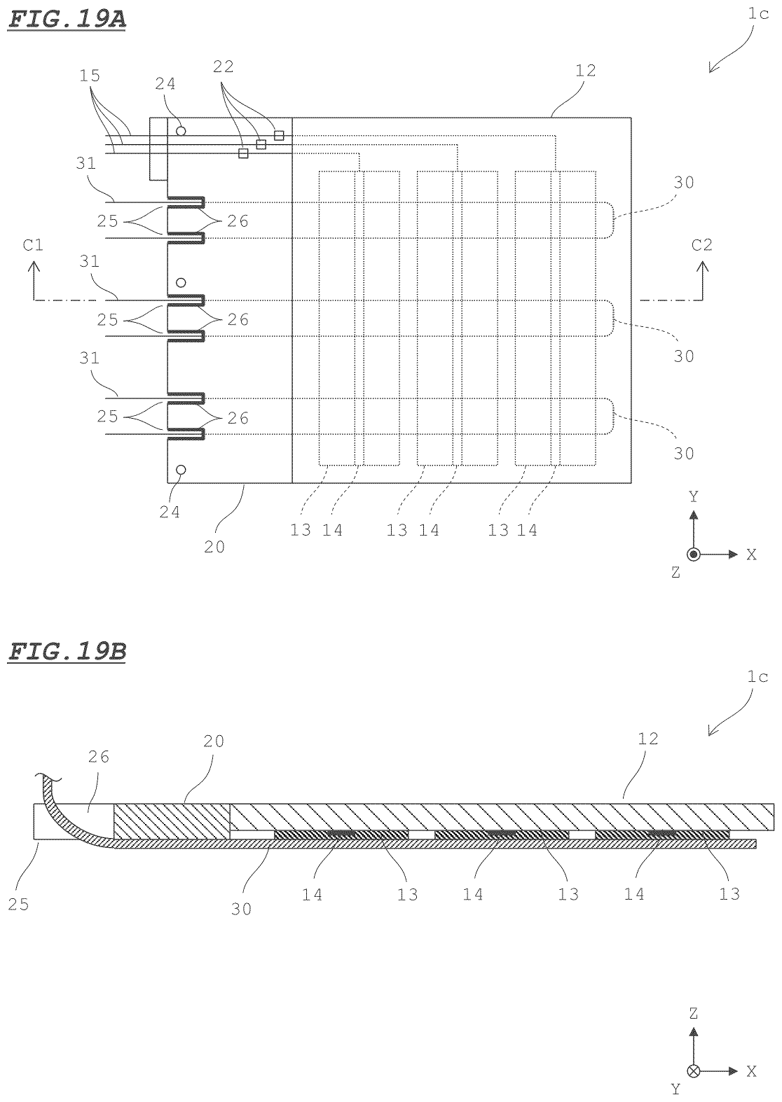

FIG. 19A is a plan view schematically showing a configuration of the structure 1c in a manufacturing step. FIG. 19B is a C1-C2 cross-sectional view of the structure 1c in FIG. 19A.

Similar to Embodiment 3 above, the structure 1a in FIG. 1A is flipped upside down and superposed on the structure 1b in FIG. 18. Accordingly, the surfaces of the three electrically-conductive elastic bodies 13 overlap the wires 30. In a state of traversing the three electrically-conductive elastic bodies 13 in the X-axis direction, each wire 30 crosses these electrically-conductive elastic bodies 13. As shown in FIG. 19B, the plurality of wires 30 are bent upwardly so as to be included in the grooves 25, respectively.

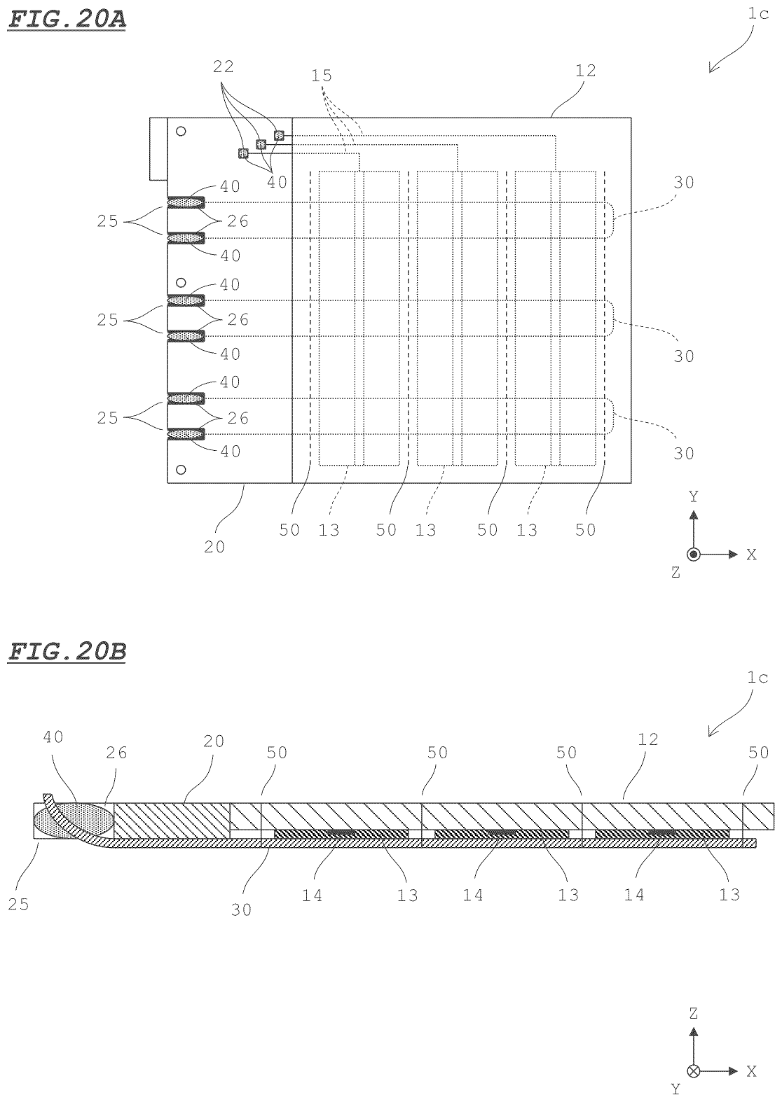

FIG. 20A is a plan view showing a state where the wires 30 are fixed by the solder 40 and the threads 50 in the structure 1c in FIG. 19A. FIG. 20B is a cross-sectional view obtained by cutting the structure 1c in FIG. 20A at the position of C1-C2 in FIG. 19A.

In the state shown in FIGS. 19A, 19B, the solder 40 is applied to each of the plurality of grooves 25. Accordingly, the conductor wire 31 of the wire 30 included in each groove 25 is joined by the solder 40 to the electrode 26 disposed at the inner side face of the groove 25. The other configurations of the structure 1c are the same as those of the structure 1c in Embodiment 3 above. Then, in a state where the three wires 30 are joined by the solder 40 to the electrodes 26 at the substrate 20, portions, of the wires 30, on the X-axis negative side with respect to the electrodes 26 are cut off. In addition, portions, of the three wiring cables 15, on the X-axis negative side with respect to the electrodes 22 are cut off.

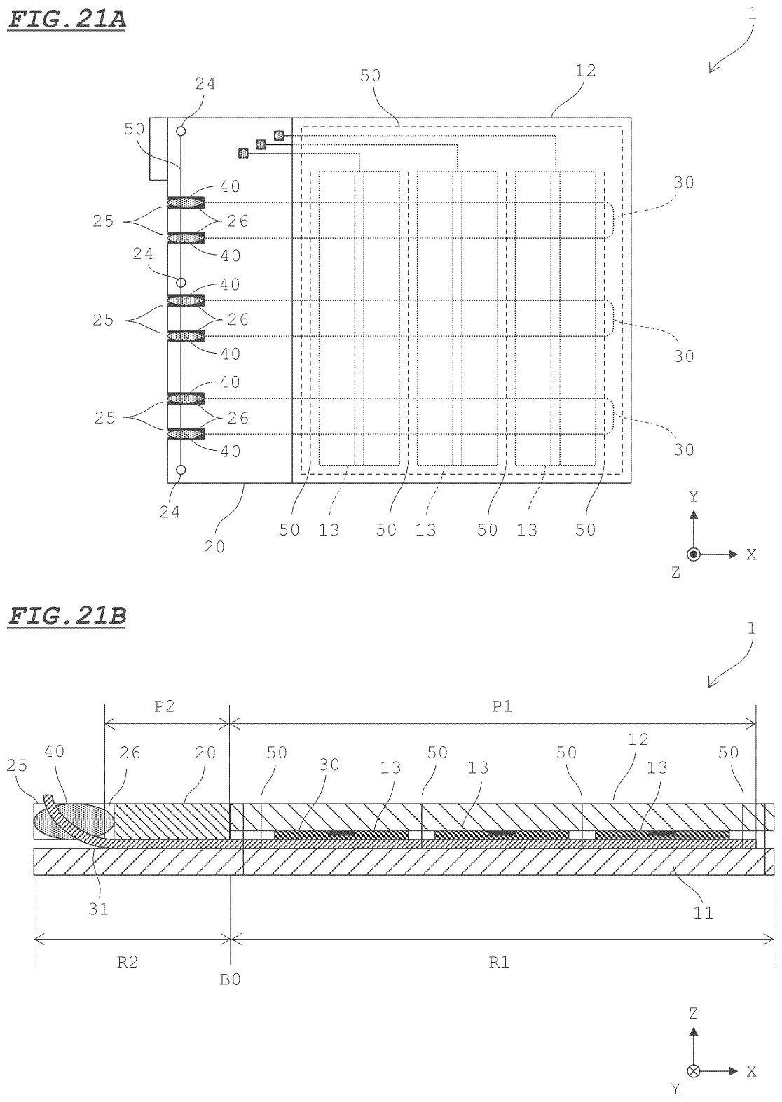

FIG. 21A is a plan view schematically showing a configuration of the load sensor 1. FIG. 21B is a cross-sectional view obtained by cutting the load sensor 1 in FIG. 21A at the position of C1-C2 in FIG. 19A.

Similar to Embodiment 3 above, in a state where the first base member 11 is superposed on the structure 1c in FIGS. 20A, 20B from below (the Z-axis negative side), the outer periphery of the second base member 12 is connected to the first base member 11 by a thread 50. Further, via the three holes 24 provided in the substrate 20, the substrate 20 is connected to the first base member 11 by a thread 50. As a result, the second base member 12 and the substrate 20 are fixed to the first base member 11. Then, the load sensor 1 is completed as shown in FIGS. 21A, 21B.

### Effects of Embodiment 4

As shown in FIGS. 21A, 21B, as a structure for disposing, at an approximately identical plane, the first portion P1 included in the first region R1 and the second portion P2 extending from the first portion P1 to the second region R2, of each of the plurality of conductor wires 31, the load sensor 1 includes the plurality of grooves 25 that are formed in the substrate 20 so as to extend inwardly (the X-axis positive direction) from the boundary of the substrate 20 on the side opposite to the first region R1, and in which the second portions P2 of the plurality of conductor wires 31 are respectively disposed. Then, the electrode 26 is disposed at the inner side face of each groove 25, and the solder 40 is applied to each groove 25, whereby the second portion P2 and the electrode 26 are joined.

Therefore, as shown in FIG. 21B, the first portion P1 and the second portion P2 are disposed at an approximately identical plane. Therefore, unlike Comparative Example in FIG. 7B, the plurality of conductor wires 31 are inhibited from being bent in the up-down direction near the boundary B0 between the first region R1 and the second region R2, and generation of a gap between: the first base member 11; and each conductor wire 31 and the second base member 12 near this boundary B0 is inhibited. Thus, the load detection characteristic can be inhibited from becoming unstable near the boundary B0.

As shown in FIGS. 21A, 21B, since the position of the solder 40 is separated from the boundary B0 between the first region R1 and the second region R2, even if the load sensor 1 is bent in the up-down direction at this boundary B0, the conductor wire 31 fixed by the solder 40 is not broken at the solder 40 end. Therefore, unlike Modification 2 of Embodiment 3 above, even when the bending inhibition member is not separately provided, breakage of the conductor wire 31 can be inhibited.

In the configuration of Embodiment 4 as well, it is preferable that the electrode 26, the solder 40, and the conductor wire 31 joined to the electrode 26 in the groove 25 are disposed in the range of the thickness T1 of the substrate 20, as in Embodiment 3 above. Accordingly, the load sensor 1 can be made thin.

### Modification of Embodiment 4

In Embodiment 4 above, the electrode 26 is disposed at the inner side face of each groove 25. However, in the present modification, the electrodes to which the plurality of conductor wires 31 are connected are disposed on the upper face of the substrate 20 on the first region R1 side with respect to the plurality of grooves 25.

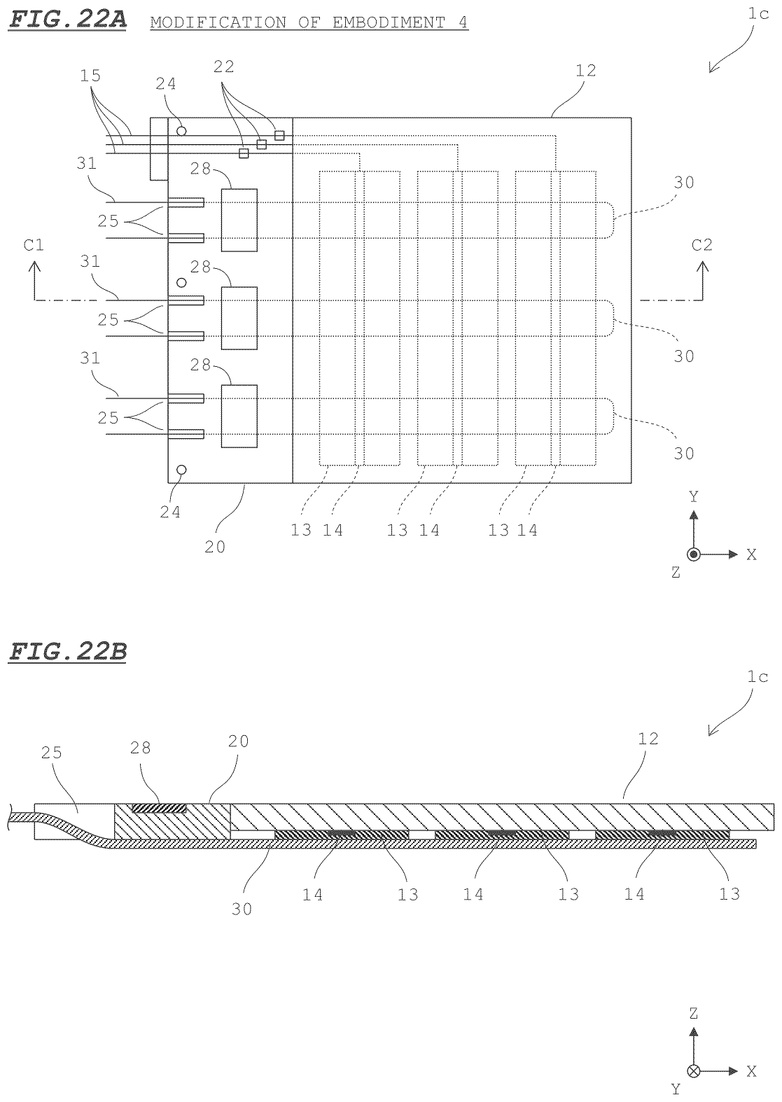

FIG. 22A is a plan view schematically showing a configuration the structure 1c in a manufacturing step. FIG. 22B is a C1-C2 cross-sectional view of the structure 1c in FIG. 22A.

As shown in FIGS. 22A, 22B, a plurality of electrodes 28 to which the plurality of conductor wires 31 are connected are disposed on the upper face of the substrate 20 on the X-axis positive side with respect to the plurality of grooves 25. The other configurations of the structure 1c are the same as to those of the structure 1c shown in FIGS. 19A, 19B.

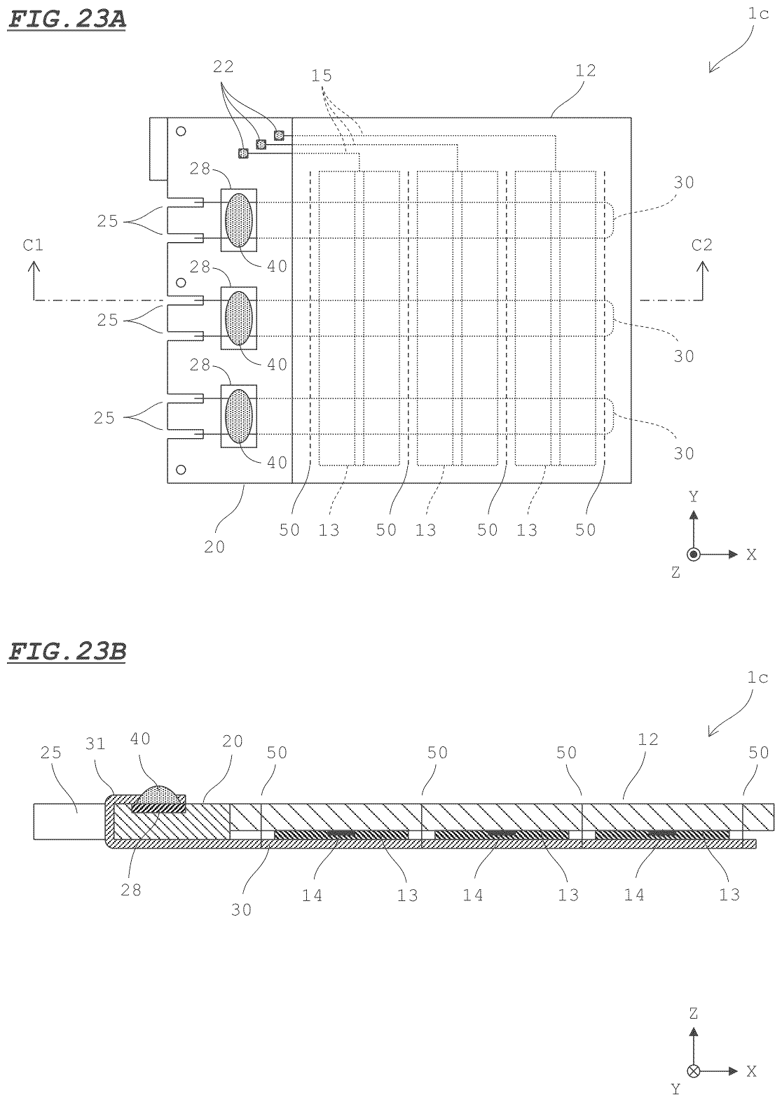

FIG. 23A is a plan view showing a state where the wires 30 are fixed by the solder 40 and the threads 50 in the structure 1c in FIG. 22A. FIG. 23B is a cross-sectional view obtained by cutting the structure 1c in FIG. 23A at the position of C1-C2 in FIG. 23A.

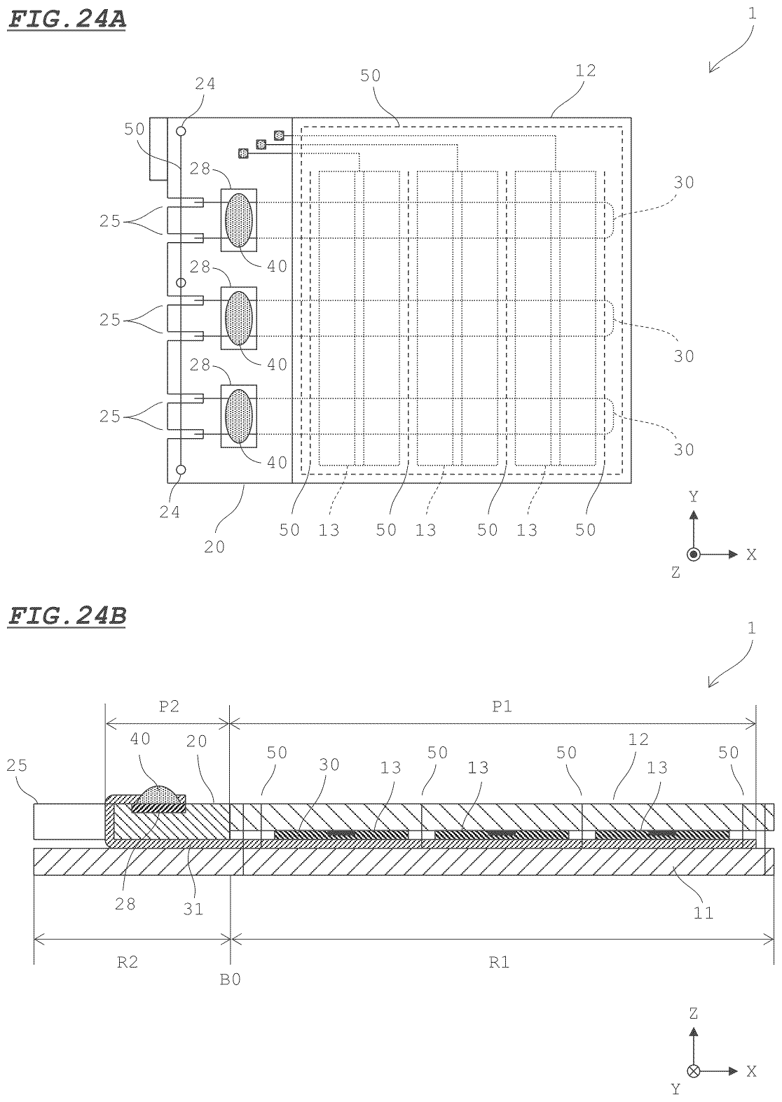

In the state shown in FIGS. 22A, 22B, the conductor wire 31 of each wire 30 is bent so as to be raised from the groove 25 onto the upper face of the substrate 20, to be joined by the solder 40 to the electrode 28 on the upper face of the substrate 20, as shown in FIGS. 23A, 23B. The other configurations of the structure 1c are the same as those of the structure 1c in Embodiment 4 above. Then, in a state where the three wires 30 are joined by the solder 40 to the electrodes 28 on the substrate 20, portions, of the wires 30, on the X-axis positive side with respect to the electrodes 28 are cut off. In addition, portions, of the three wiring cables 15, on the X-axis negative side with respect to the electrodes 22 are cut off. As a result, the structure 1c in FIGS. 23A, 23B is formed. FIG. 24A is a plan view schematically showing a configuration of the load sensor 1. FIG. 24B is a cross-sectional view obtained by cutting the load sensor 1 in FIG. 24A at the position of C1-C2 in FIG. 22A.

Similar to Embodiment 4 above, in a state where the first base member 11 is superposed on the structure 1c in FIGS. 23A, 23B from below (the Z-axis negative side), the outer periphery of the second base member 12 is connected to the first base member 11 by a thread 50. Further, via the three holes 24 provided in the substrate 20, the substrate 20 is connected to the first base member 11 by a thread 50. As a result, the second base member 12 and the substrate 20 are fixed to the first base member 11. Then, the load sensor 1 is completed as shown in FIGS. 24A, 24B.

In this modification as well, the first portions P1 and the second portions P2 are disposed at an approximately identical plane, as in Embodiment 4 above. Thus, the load detection characteristic can be inhibited from becoming unstable near the boundary B0 of the substrate 20.

### Other Modifications

In Embodiments 1 to 4 above and the modifications thereof, the electrically-conductive elastic bodies 13 are disposed on the opposing face 12a of the second base member 12. However, electrically-conductive elastic bodies may be disposed on the first base member 11 side.

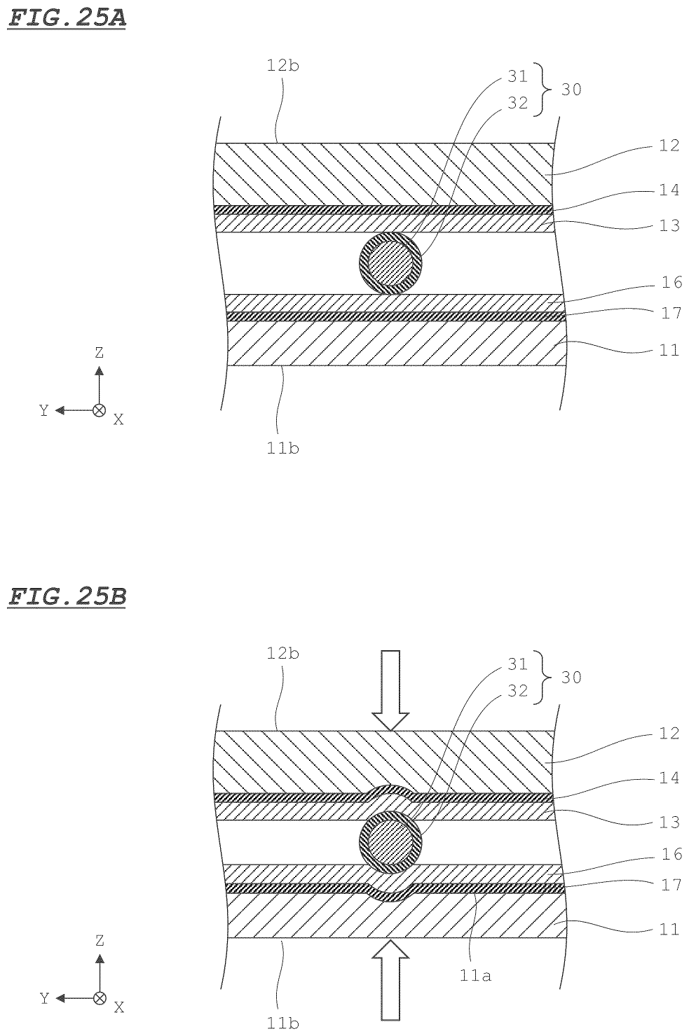

For example, in the configurations of Embodiments 3, 4 above and the modifications thereof, as shown in FIGS. 25A, 25B, electrically-conductive elastic bodies 16 may be disposed on an opposing face 11a of the first base member 11 so as to respectively oppose the plurality of electrically-conductive elastic bodies 13 on the second base member 12. In this case, on the opposing face 11a of the first base member 11, electric conductors 17 are formed so as to oppose the electric conductors 14 on the second base member 12, and further, the electrically-conductive elastic bodies 16 are formed so as to cover the electric conductors 17. The electrically-conductive elastic bodies 16 and the electric conductors 17 may be formed by the materials and the manufacturing methods for the electrically-conductive elastic bodies 13 and the electric conductors 14. In this case, the first base member 11 may be formed from a material having a hardness similar to that of the second base member 12. In the configurations of Embodiments 1, 2 above, a plurality of electrically-conductive elastic bodies and a plurality of electric conductors similar to those in FIGS. 25A, 25B may be formed on the upper faces of the spacer 60 and the spacer 61.

The plurality of electrically-conductive elastic bodies and the plurality of electric conductors may be formed only on the first base member 11 side. In this case, the load sensor 1 is flipped upside down and set such that the load is applied to the lower face (the face on the Z-axis negative side) of the first base member 11.

In Embodiments 1, 2 above, the spacer 60, 61 having a size that covers the first region R1 and the region near the boundary B0 of second region R1 is disposed. However, as long as the first portion P1 and the second portion P2 can be disposed at an approximately identical plane, the spacer 60, 61 may have another configuration. For example, in a region between adjacent wires 30, the spacer 60, 61 may be omitted, and three spacers 60, 61 that respectively cover only the regions corresponding to the three wires 30 may be disposed. Similarly, the spacer 62 may also have a configuration other than the above.

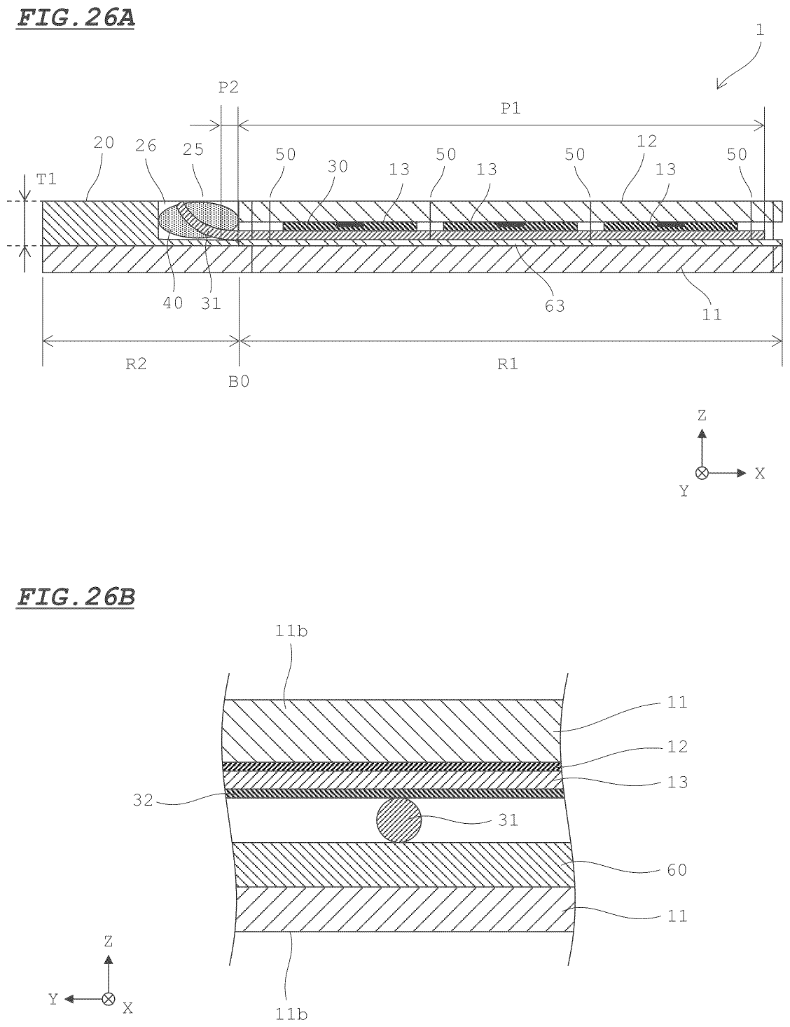

In Embodiment 3 above and the modifications thereof, each groove 25 penetrates in the Z-axis direction. However, the groove 25 need not necessarily penetrate. For example, as shown in FIG. 26A, each groove 25 need not necessarily penetrate in the configuration of Embodiment 3 above. In this case, a spacer 63 for raising the wire 30 (the first portion P1) in the first region R1 up to the height of the bottom face of the groove 25 is set on the upper face of the first base member 11 in the first region R1. In this case, the electrode 26 may be disposed not only at the side face of the groove 25 but also at the bottom face thereof.

The shape of the groove 25 need not necessarily be rectangular in a plan view, and may have another shape as long as the second portion P2 can be disposed therein. For example, the shape of the groove 25 in a plan view may be a shape obtained by rounding the corners of a rectangle.

In Embodiments 1 to 4 above and the modifications thereof, the wire 30 (conductor wire 31, dielectric body 32) extends in a straight line shape between the first region R1 and the second region R2. However, the wire 30 may meander so as to oscillate in the Y-axis direction in the first region R1. The direction in which the wire 30 extends need not necessarily be the X-axis direction, and may be tilted from the X-axis direction. In this case, in Embodiments 3, 4, the groove 25 may also be tilted in accordance with the tilt of the wire 30.

In Embodiments 1 to 4 above and the modifications thereof, the threads 50 are used for connection between: the first base member 11; and the second base member 12 and the substrate 20. However, another fixation tool such as a caulking tool may be used for this connection.

In Embodiments 1 to 4 above and the modifications thereof, the dielectric body 32 is disposed on the surface of conductor wire 31. However, the dielectric body 32, which defines the capacitance between the conductor wire 31 and the electrically-conductive elastic body 13, may be disposed between the conductor wire 31 and the electrically-conductive elastic body 13. For example, as shown in FIG. 26B, in the configuration of Embodiment 1 above, the dielectric body 32 may be disposed on the surface of the electrically-conductive elastic body 13. In this case, the dielectric body 32 is formed from a material that can be elastically deformed so that the contact area with the conductor wire 31 changes in accordance with the load. For example, the dielectric body 32 is formed from a material having an elastic modulus similar to that of the electrically-conductive elastic body 13.

In Embodiments 1 to 4 above and the modifications thereof, three wires 30 bent back on the X-axis positive side are disposed, and two portions of each wire 30 are disposed on one element part A1. However, the number of wires 30 and the number of wires 30 included in the element part A1 are not limited thereto. In Embodiments 1 to 4 above and the modifications thereof, each wire 30 is disposed while being bent back near the end portion on the X-axis positive side of the first region R1. However, each wire 30 may be cut at this bending-back position.

In Embodiments 1 to 4 above and the modifications thereof, the method of disposing the electrically-conductive elastic bodies 13 on the opposing face 12a of the second base member 12 is not necessarily limited to printing, and another method such as adhering a foil may be adopted.

In Embodiments 1 to 4 above and the modifications thereof, the width of the electrically-conductive elastic body 13 need not necessarily be constant. For example, in the ranges between the element parts A1 in the direction (the Y-axis direction) in which the electrically-conductive elastic body 13 extends, the width of the electrically-conductive elastic body 13 may be narrowed. In Embodiments 1 to 4 above and the modifications thereof, the electric conductor 14 may be omitted, and the wiring cable 15 may be connected to the electrically-conductive elastic body 13.

In addition to the above, various modifications can be made as appropriate to the embodiments of the present invention without departing from the scope of the technical idea defined by the claims.

### (Additional Note)

The following technologies are disclosed by the description of the embodiments above.

### (Technology 1)

A load sensor including:
a first base member;
a second base member covering at least a first region of the first base member;
a plurality of conductor wires disposed so as to extend across the first region and a second region of the first base member adjacent to the first region;
a plurality of electrically-conductive elastic bodies disposed on at least one of opposing faces of the first base member and the second base member, the plurality of electrically-conductive elastic bodies each crossing the plurality of conductor wires;
a dielectric body disposed between the conductor wire and the electrically-conductive elastic body;
a substrate set on the first base member in the second region and having electrodes to which the plurality of conductor wires are fixed by solder; and
a structure configured to dispose, at an approximately identical plane, a first portion included in the first region and a second portion extending from the first portion to the second region, of each of the plurality of conductor wires.

### (Effects of Technology 1)

The first portion of each of the plurality of conductor wires included in the first region and the second portion of each of the plurality of conductor wires extending from the first portion to the second region are disposed at an approximately identical plane. Therefore, the plurality of conductor wires are inhibited from being bent in the up-down direction near the boundary between the first region and the second region, and generation of a gap between: the first base member; and each conductor wire and the second base member near this boundary is inhibited. Therefore, the load detection characteristic can be inhibited from becoming unstable near the boundary of the substrate.

### (Technology 2)

The load sensor according to technology 1, wherein
the structure includes a plurality of grooves that are formed in the substrate so as to extend inwardly from a boundary of the substrate on the first region side, and in which the second portions of the plurality of conductor wires are respectively disposed.

### (Effects of Technology 2)

With a simple configuration in which the grooves are formed in the substrate, the first portions and the second portions of the plurality of conductor wires can be disposed at an approximately identical plane. Therefore, the configuration of the load sensor can be simplified.

### (Technology 3)

The load sensor according to technology 2, wherein
the electrode is disposed at a periphery of each of the grooves, and
in a state of being accommodated in the groove, the conductor wire is joined to the electrode by solder.

### (Technology 4)

The load sensor according to technology 3, wherein the electrode is disposed at an inner side face of each of the grooves.

### (Effects of Technologies 3, 4)

Since the second portion is accommodated in the groove, the load sensor can be made thinner as compared with a case where the conductor wire is routed and fixed by solder onto the upper face of the substrate. In addition, through a simple step of applying solder to the groove in a state where the conductor wire is accommodated in the groove, the conductor wire and the electrode can be electrically joined to each other.

### (Technology 5)

The load sensor according to technology 4, wherein
the electrode, the solder, and the conductor wire joined to the electrode in the groove are disposed in a range of a thickness of the substrate.

### (Effects of Technology 5)

Since the electrode, the solder, and the conductor wire joined to the electrode in the groove are disposed in the range of the thickness of the substrate, these do not protrude beyond the range of the thickness of the substrate. Thus, the load sensor can be made further thinner.

### (Technology 6)

The load sensor according to any one of technologies 3 to 5, including
a bending inhibition member configured to inhibit the load sensor from being bent in an up-down direction at a boundary between the first region and the second region.

### (Technology 7)

The load sensor according to technology 6, wherein
the bending inhibition member is a reinforcement film superposed on an upper face of the second base member and an upper face of the substrate near the boundary.

### (Effects of Technologies 6, 7)

Even if a force that may cause the load sensor to be bent at the boundary between the first region and the second region is applied to the load sensor, this bending is inhibited by the bending inhibition member such as a reinforcement film. Therefore, the conductor wire near the boundary fixed by the solder can be inhibited from being broken at the solder end due to this bending.

### (Technology 8)

The load sensor according to any one of technologies 3 to 7, wherein
in each of the grooves, the electrode is not disposed in a predetermined range inward of the boundary, and the electrode is disposed on a far side with respect to the range.

### (Effects of Technology 8)

Since the position of the solder is separated from the boundary between the first region and the second region, even if the load sensor is bent in the up-down direction at this boundary, the conductor wire fixed by the solder is not broken at the solder end. Therefore, breakage of the conductor wire due to this bending can be inhibited.

### (Technology 9)

The load sensor according to technology 2, wherein
the plurality of electrodes are disposed on an upper face of the substrate on a far side with respect to the plurality of grooves, and
each of the conductor wires is bent so as to be raised from a state of being accommodated in the groove onto the upper face of the substrate, to be joined to the electrode by solder.

### (Effects of Technology 9)

The first portions and the second portions of the plurality of conductor wires are disposed at an approximately identical plane. Therefore, generation of a gap between: the first base member; and each conductor wire and the second base member near the boundary can be inhibited. Thus, the load detection characteristic can be inhibited from becoming unstable near the boundary of the substrate.

### (Technology 10)

The load sensor according to technology 1, wherein the structure includes a plurality of grooves that are formed in the substrate so as to extend inwardly from a boundary of the substrate on a side opposite to the first region, and in which the second portions of the plurality of conductor wires are respectively disposed.

### (Technology 11)

The load sensor according to technology 10, wherein
the electrode is disposed at an inner side face of each of the grooves, and
the conductor wire and the electrode are joined to each other through application of solder to each of the grooves.

### (Effects of Technologies 10, 11)

The first portions and the second portions of the plurality of conductor wires are disposed at an approximately identical plane. Therefore, the plurality of conductor wires are inhibited from being bent in the up-down direction near the boundary between the first region and the second region, and generation of a gap between: the first base member; and each conductor wire and the second base member near this boundary is inhibited. Thus, the load detection characteristic can be inhibited from becoming unstable near the boundary of the substrate.

### (Technology 12)

The load sensor according to technology 10, wherein
the plurality of electrodes are disposed on an upper face of the substrate on the first region side with respect to the plurality of grooves, and
each of the conductor wires is bent so as to be raised from the groove onto the upper face of the substrate, to be joined to the electrode by solder.

### (Effects of Technologies 10, 12)

The first portions and the second portions of the plurality of conductor wires are disposed at an approximately identical plane. Therefore, the load detection characteristic can be inhibited from becoming unstable near the boundary of the substrate.

### (Technology 13)

The load sensor according to technology 1, wherein
the plurality of electrodes are disposed on an upper face of the substrate, and
the structure includes a spacer configured to align a height of the first portion in the first region with a height of the upper face of the substrate.

### (Effects of Technology 13)

Since the height of the first portion is aligned with the height of the upper face of the substrate by the spacer, the first portions and the second portions of the plurality of conductor wires are disposed at an approximately identical plane. Therefore, the plurality of conductor wires are inhibited from being bent in the up-down direction near the boundary between the first region and the second region, and generation of a gap between: the first base member; and each conductor wire and the second base member near this boundary is inhibited. Thus, the load detection characteristic can be inhibited from becoming unstable near the boundary of the substrate.

### (Technology 14)

The load sensor according to technology 1, wherein
the plurality of electrodes are disposed on a lower face of the substrate, and
the structure includes a spacer configured to: fill a gap generated between the lower face of the substrate and an upper face of the first base member, with solder that joins the second portion to the electrode; and dispose the first portion and the second portion at an approximately identical plane.

### (Effects of Technology 14)

Since the height of the first portion is aligned with the height of the lower face of the substrate by the spacer, the first portions and the second portions of the plurality of conductor wires are disposed at an approximately identical plane. Therefore, the plurality of conductor wires are inhibited from being bent in the up-down direction near the boundary between the first region and the second region, and generation of a gap between: the first base member; and each conductor wire and the second base member near this boundary is inhibited. Thus, the load detection characteristic can be inhibited from becoming unstable near the boundary of the substrate.

What is claimed is:

1. A load sensor comprising:
a first base member;
a second base member covering at least a first region of the first base member;
a plurality of conductor wires disposed so as to extend across the first region and a second region of the first base member adjacent to the first region;
a plurality of electrically-conductive elastic bodies disposed on at least one of opposing faces of the first base member and the second base member, the plurality of electrically-conductive elastic bodies each crossing the plurality of conductor wires;
a dielectric body disposed between the conductor wire and the electrically-conductive elastic body;
a substrate set on the first base member in the second region and having electrodes to which the plurality of conductor wires are fixed by solder; and
a structure configured to dispose, at an approximately identical plane, a first portion included in the first region and a second portion extending from the first portion to the second region, of each of the plurality of conductor wires.

2. The load sensor according to claim 1, wherein
the structure includes a plurality of grooves that are formed in the substrate so as to extend inwardly from a boundary of the substrate on the first region side, and in which the second portions of the plurality of conductor wires are respectively disposed.

3. The load sensor according to claim 2, wherein
the electrode is disposed at a periphery of each of the grooves, and
in a state of being accommodated in the groove, the conductor wire is joined to the electrode by solder.

4. The load sensor according to claim 3, wherein
the electrode is disposed at an inner side face of each of the grooves.

5. The load sensor according to claim 4, wherein
the electrode, the solder, and the conductor wire joined to the electrode in the groove are disposed in a range of a thickness of the substrate.

6. The load sensor according to claim 3, comprising
a bending inhibition member configured to inhibit the load sensor from being bent in an up-down direction at a boundary between the first region and the second region.

7. The load sensor according to claim 6, wherein
the bending inhibition member is a reinforcement film superposed on an upper face of the second base member and an upper face of the substrate near the boundary.

8. The load sensor according to claim 3, wherein
in each of the grooves, the electrode is not disposed in a predetermined range inward of the boundary, and the electrode is disposed on a far side with respect to the range.

9. The load sensor according to claim 2, wherein
the plurality of electrodes are disposed on an upper face of the substrate on a far side with respect to the plurality of grooves, and
each of the conductor wires is bent so as to be raised from a state of being accommodated in the groove onto the upper face of the substrate, to be joined to the electrode by solder.

10. The load sensor according to claim 1, wherein
the structure includes a plurality of grooves that are formed in the substrate so as to extend inwardly from a boundary of the substrate on a side opposite to the first region, and in which the second portions of the plurality of conductor wires are respectively disposed.

11. The load sensor according to claim 10, wherein
the electrode is disposed at an inner side face of each of the grooves, and
the conductor wire and the electrode are joined to each other through application of solder to each of the grooves.

12. The load sensor according to claim 10, wherein
the plurality of electrodes are disposed on an upper face of the substrate on the first region side with respect to the plurality of grooves, and
each of the conductor wires is bent so as to be raised from the groove onto the upper face of the substrate, to be joined to the electrode by solder.

13. The load sensor according to claim 1, wherein
the plurality of electrodes are disposed on an upper face of the substrate, and
the structure includes a spacer configured to align a height of the first portion in the first region with a height of the upper face of the substrate.

14. The load sensor according to claim 1, wherein
the plurality of electrodes are disposed on a lower face of the substrate, and
the structure includes a spacer configured to: fill a gap generated between the lower face of the substrate and an upper face of the first base member, with solder that joins the second portion to the electrode; and dispose the first portion and the second portion at an approximately identical plane.
